(19) United States
(12) Patent Application Publication
(10) Pub. No.: US 2018/0007443 A1
(43) Pub. Date: Jan. 4, 2018

(54) PERSONALIZED, INTERACTIVE, AND UNINTERRUPTED VIDEO CONTENT STREAMING SYSTEM

(71) Applicants: Alan C Cannistraro, San Francisco, CA (US); Andrew C Johnson, London (CA); Timothy J Buick, Ottawa (CA); Guatam S Bannerjee, Ottawa (CA); Olivier Testellin-Dumetz, Ottawa (CA)

(72) Inventors: Alan C Cannistraro, San Francisco, CA (US); Andrew C Johnson, London (CA); Timothy J Buick, Ottawa (CA); Guatam S Bannerjee, Ottawa (CA); Olivier Testellin-Dumetz, Ottawa (CA)

(73) Assignee: copper studios, inc., san francisco, CA (US)

(21) Appl. No.: 15/598,208

(22) Filed: May 17, 2017

Related U.S. Application Data
(60) Provisional application No. 62/338,435, filed on May 18, 2016.

(51) Int. Cl. H04N 21/472; H04N 21/431; H04N 21/258; H04N 21/44; H04N 21/25

(52) U.S. Cl. CPC H04N 21/47217; H04N 21/44004; H04N 21/251; H04N 21/25891; H04N 21/4312

(57) ABSTRACT

A video delivery system with client side touchscreen scrub control and multi-clip simultaneous buffering ability. Advanced scrub control provides improved fine and gross navigation control. The client works in conjunction with a sequence server to coordinate an individualized stream of sequenced clips for the user. User viewing habits continually influence what clips are next selected for the user.

### CROSS REFERENCE TO RELATED APPLICATIONS

This application is related to applications entitled: “Streaming Tailored Television And Control System For Same,” attorney docket No. CS100.U1 and “Viewing Habit Influenced Clip And Sequence Selection In An Individualized Video Delivery System,” attorney docket No. CS100.U3 filed concurrently with the present application, each of which is hereby incorporated by reference in the entirety into this application. This application claims the benefit of provisional patent application 62/338,435 to A. Cannistraro et al, entitled “Personalized, Interactive, and Uninterrupted Video Content Streaming System,” and to provisional patent application 62/487,200 to A. Cannistraro et al, entitled “Multi Source Video Service with Integrated Social Interaction,” which are also hereby incorporated by reference in the entirety for all purposes into this application.

A computer program listing appendix with source code is submitted as part of this application, forms part of this specification, and is hereby incorporated by reference in the entirety.

### BACKGROUND OF THE INVENTION

This invention relates generally to microprocessor controlled video delivery and viewing systems and devices, and the selection and personalization of the content streams provided using them.

People are able to make decisions about video content very quickly. Generally, people are able to tell in hundreds of milliseconds whether they want to watch a clip or not. Using most current interfaces, it takes multiple seconds for a user to change from one piece of video content to another. For example, on most cable boxes, where content is organized linearly as channels, there is a stream decode time of >1 s and often about 2 s or more to change from one channel to another. On systems where channel changing is fast, for example on analog TVs receiving over the air “OTA” signals such as ABC, NBC, or CBS, the easily or quickly accessible content is limited to a small set of what is on another adjacent channel and cannot be altered.

For on-demand content, most content is arranged in menus, with groupings by genre, playlist, artist/creator, etc. It takes several seconds for a user to get from one clip to the next because of the time it takes to traverse menus to scan for and select another clip. For on-demand content where skipping is permitted, the user must often wait for the system to buffer the next clip. For on-demand content where skipping is possible, systems make scrubbing of a clip (traversing time within a clip) difficult and inefficient, with either poor controls or with controls that require multiple steps to access, or by a combination of the two. For example, the typical forward or reverse scan control on a remote that moves forward at 2×, 4×, 8× etc. requires multiple clicks to advance at fast forward rate that allows the user to move ahead more than a few minutes in a short period, and also requires the user to watch an overly large amount of programming they may not wish to watch and would care to skip altogether or at a more rapid rate. As another example, moving a linear slider bar on a touch screen or with a mouse is a quite difficult on a small screen and is difficult to control with any acceptable degree of precision.

### SUMMARY

The system and methods described herein overcome the drawbacks of modern media streaming while providing the ability to easily and instantly provide, select, and view media tailored to a user from a nearly infinite universe of material. In one embodiment, user viewing habits are used to determine what should be shown next and what other options are queued up and instantly available should the user prefer to move onto something else after having viewed some portion of a first video segment determined to be of potential interest to the user and/or the user's guests and proximate viewers.

Some embodiments and advantages involve an interaction method on a track pad or touch screen where the user can perform any one of the following three actions at any time during video playback, without additional menus: 1) skipping; 2) scrubbing; 3) taking action.

One aspect relates to a video display system or device configured to interpret movement on the touchpad or touchscreen of the system to either skip, scrub or act on the video content be displayed. The video display device (or client thereon) sends a message to a sequence server to inform of an action, as interpreted from motion sensed at the touchpad. Some examples of touchpad motion, are skip, scrub, play, like, boost, share, or comment. Certain actions, whether on the touchpad/touchscreen or other input device, may trigger changes to the sequence or queue; if these events are triggered, the sequence server sends a signal to the video display device to purge unplayed clips in a queue, and replace with new set of ‘n’ clips. For example, skipping quickly through multiple clips of a certain genre may cause the server to send fewer clips of that genre.

Another aspect of the invention relates to delivering a personalized selection of content using-the above user input as information rather than a system of menus and submenus that a user must navigate to choose content to watch.

Yet another aspect relates to a system of clip buffers with dynamic allocation within loading bays and a sliding window that expands and contracts based upon system resources, user inputs and anticipated or potential user inputs. This results in lag free video delivery for the user, even when rapidly skipping through numerous videos located on distant content servers where latency would normally be an issue.

### BRIEF DESCRIPTION OF THE DRAWINGS

FIG. 1A is a system diagram according to a disclosed embodiment of the present invention.

FIG. 1B is a schematic diagram of client 100 according to a disclosed embodiment of the present invention.

FIG. 2 is an illustration of swiping to skip backward or forwards through videos according to a disclosed embodiment of the present invention.

FIG. 3 is an illustration of scrubbing using the touchpad/touchscreen of client 100 according to a disclosed embodiment of the present invention.

FIG. 4A is a flow chart illustrating aspects of the operation of the system shown in FIG. 1.

FIG. 4B is a schematic illustration of aspects of interaction between logical components of sequence server 300 and a viewing client/device, according to a disclosed embodiment of the present invention.

FIG. 4C is a schematic illustration of aspects of interaction between logical components of sequence server 300 and a viewing client/device, according to a disclosed embodiment of the present invention.

FIG. 4D is a schematic illustration of aspects of interaction between logical components of sequence server 300 and a viewing client/device, according to a disclosed embodiment of the present invention.

FIG. 5 is a simplified illustration of an exemplary scoring process or algorithm for determining what video “clips” will be offered to a user based upon user viewing of clips according to a disclosed embodiment of the present invention.

FIG. 6 is an illustration of clip recommendation strategies according to a disclosed embodiment of the present invention.

FIG. 7 illustrates a filler configurator according to an embodiment.

FIG. 8 is an illustration depicting clip objects and actions relating to clip objects.

FIG. 9 is an exemplary illustration depicting aspects of scoring according to an embodiment.

FIGS. 10A-10K depict aspects of clip loading.

FIG. 11 is a graph of the rating decay over time, according to an embodiment utilizing decay in scoring/selecting/finding.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention. All printed references and publications referred to in this application and hereby incorporated by reference in the entirety.

A computer program listing appendix with source code is submitted as part of this application, forms part of this specification, and is hereby incorporated by reference in the entirety.

The system and methods described herein overcome the drawbacks of modern media streaming and television viewing while providing the ability to easily and instantly provide, select, and view media tailored to a user from a nearly infinite universe of material. In one embodiment, user viewing habits are used to determine what should be shown next and what other options are queued up and instantly available should the user prefer to move onto something else after having viewed some portion of a first video segment determined to be of potential interest to the user and/or the user's guests and proximate viewers.

According to one embodiment, a track pad or touch screen is utilized and the system is configured to cause skipping, scrubbing, and taking action with specialized gestures or actions that enhance and enable seamless video clip navigation.

Another aspect of the invention relates to a system for delivering a personalized selection of content using only minimal user input generated from user viewing habits, e.g. the aforementioned skipping, scrubbing, and taking action as opposed to relying on systems of menus and sub menus to navigate and select content. Automated user tailored content is delivered as a result, in many cases without the need for the user to make any selection at all.

Other aspects relate to lag free video delivery for the user, even when rapidly skipping through numerous videos located on content servers potentially far away where latency would normally be an issue. For a user to understand the video delivery to be lag free, the time between clips should not exceed 600 milliseconds, and will more ideally be around 300 milliseconds. A user may still perceive delivery to be lag free at 500-600 milliseconds if a minimal transition effect is employed in situations where bandwidth or other system constraints result in a cue time greater than 300 milliseconds.

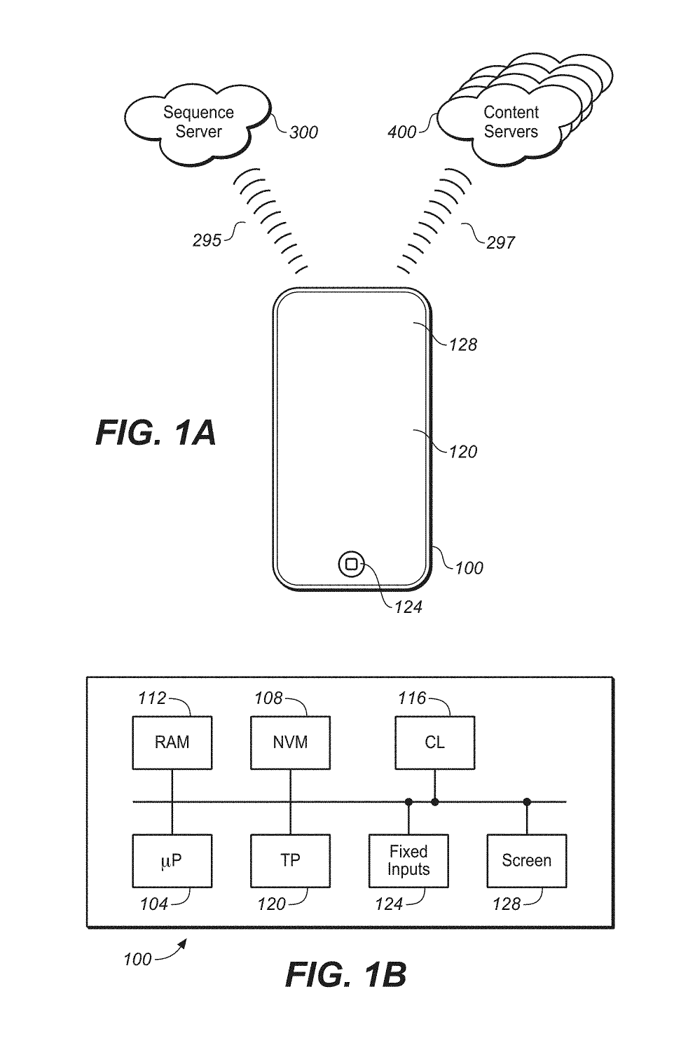

FIG. 1A is a system diagram according to a disclosed embodiment of the present invention. Looking at FIG. 1A, a user (not shown) accesses video viewing device 100 which is preferably a cellular telephone handset or tablet computing device. While both such devices are handheld and can be operated by the same fingers of the same hand holding the unit, device 100 may be a laptop, but it should be understood that a laptop cannot be held in a palm of a human hand while being operated by the same hand. Device 100 accesses the Internet and communicates via 802.11 aka “Wi-Fi” links, RF links such as “Bluetooth” and near field communications, and various cellular standards such as ETSI or 3GPP long term evolution (“LTE”). Such a device may also wirelessly broadcast a video output signal to another external screen (not shown) via 802.11 or other wireless or wired link e.g. HDMI. Other system components such as the content servers and sequence server are not at the user premises, but are instead remotely located, for example, in the “cloud.”

As seen in FIGS. 1A and 1B, device 100 comprises a microprocessor 104, touchpad 120, fixed button inputs 124 e.g. dedicated input buttons and/or keyboard, random access memory (“RAM”) 112, non volatile memory 108 such as flash memory, a hard disk, or ROM, communications link 116, and video screen 128 in certain embodiments. In an embodiment such as the cellular handset shown in FIG. 1, the touchpad (sometimes referred to as a track pad) is integrated into an assembly with the video screen and may also be referred to as a touchscreen.

A plurality of buffers, e.g. one for each stream that a user may quickly swipe to is set up in RAM memory and filled to have a minimum of 5 s worth of rendered content, although it will preferably have 10 seconds or more of rendered content.

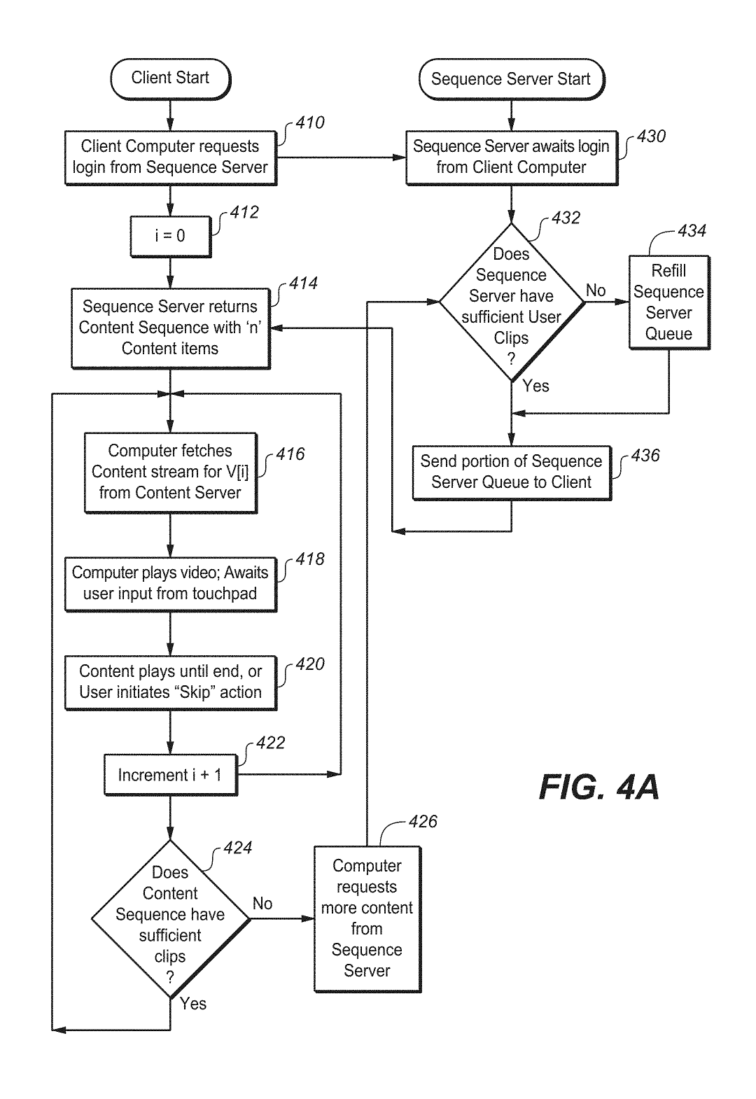

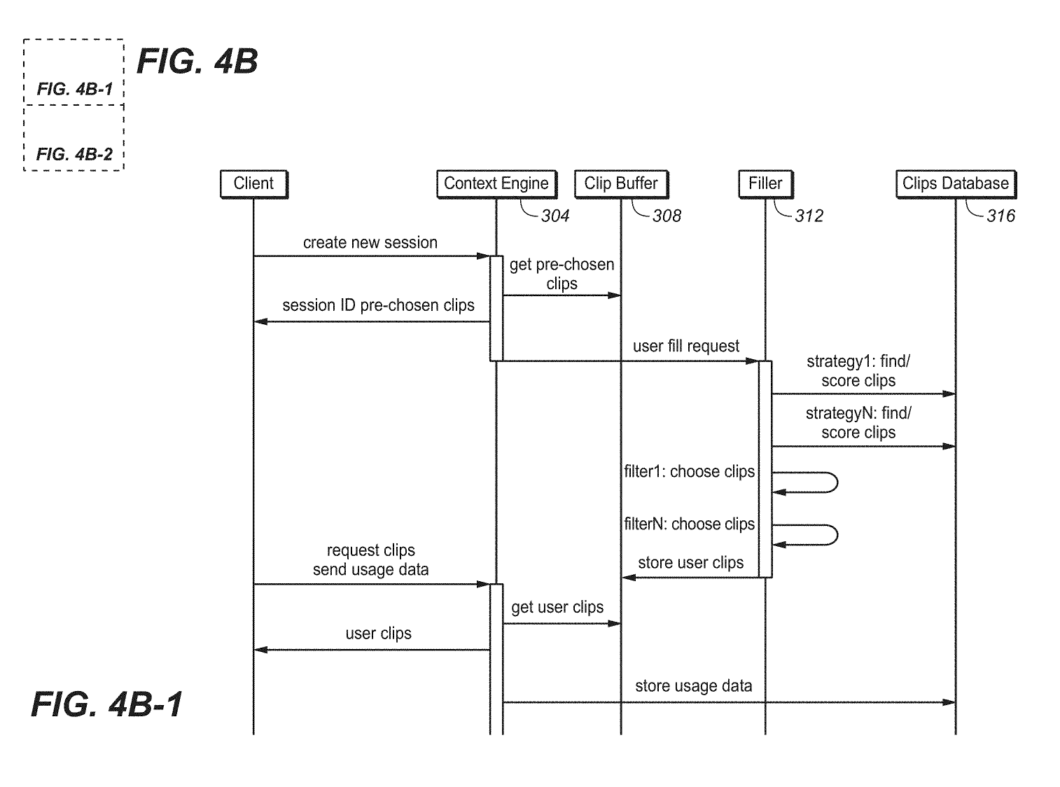

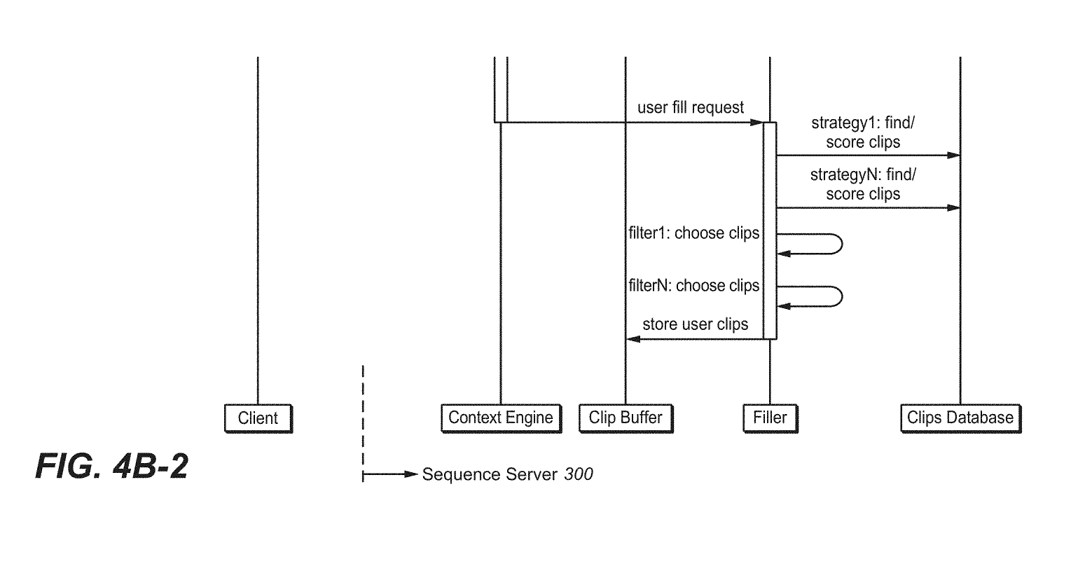

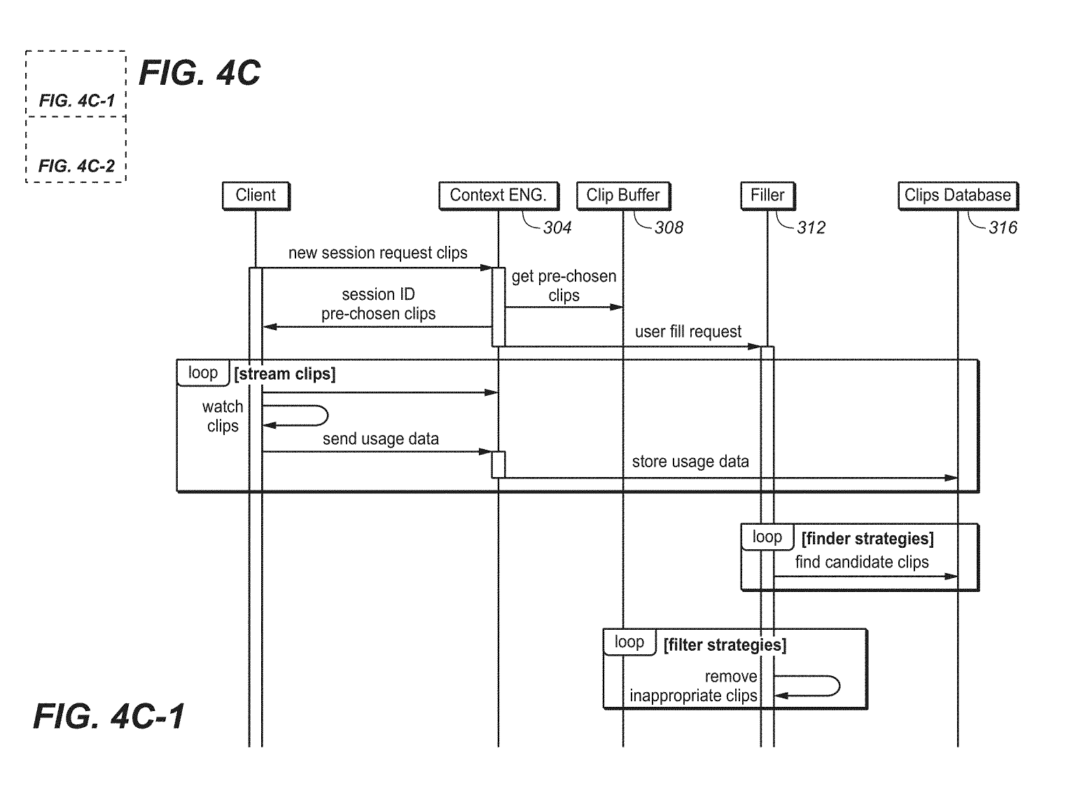

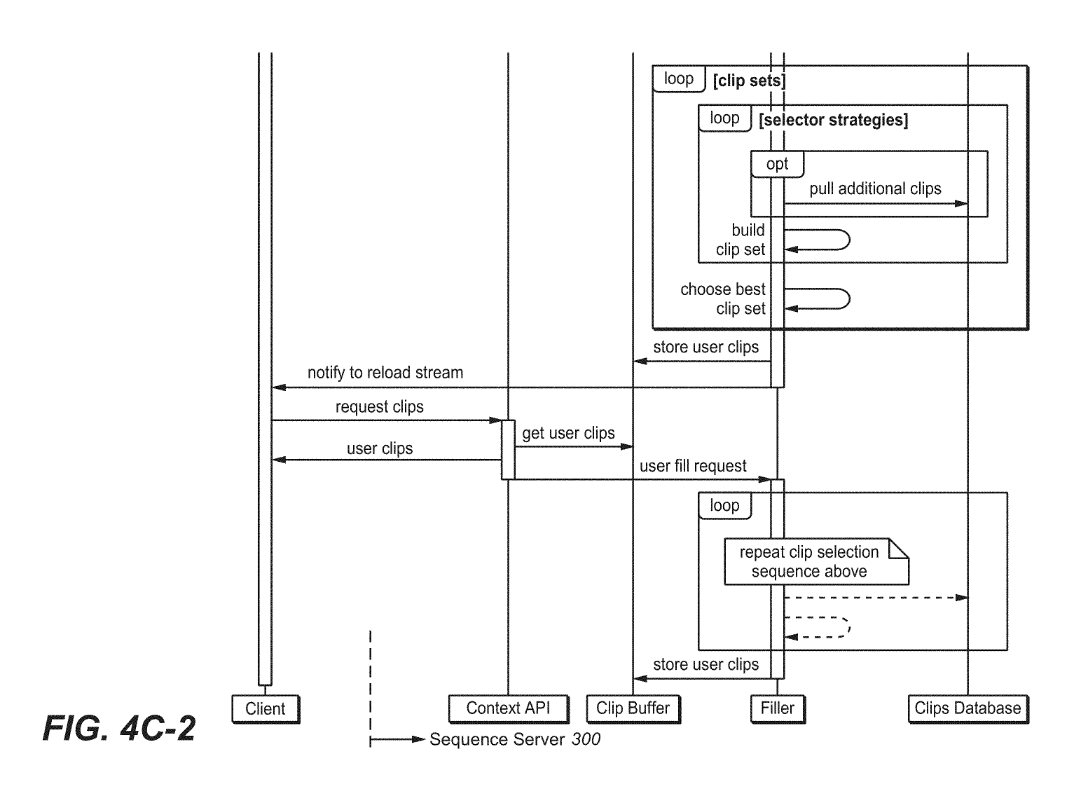

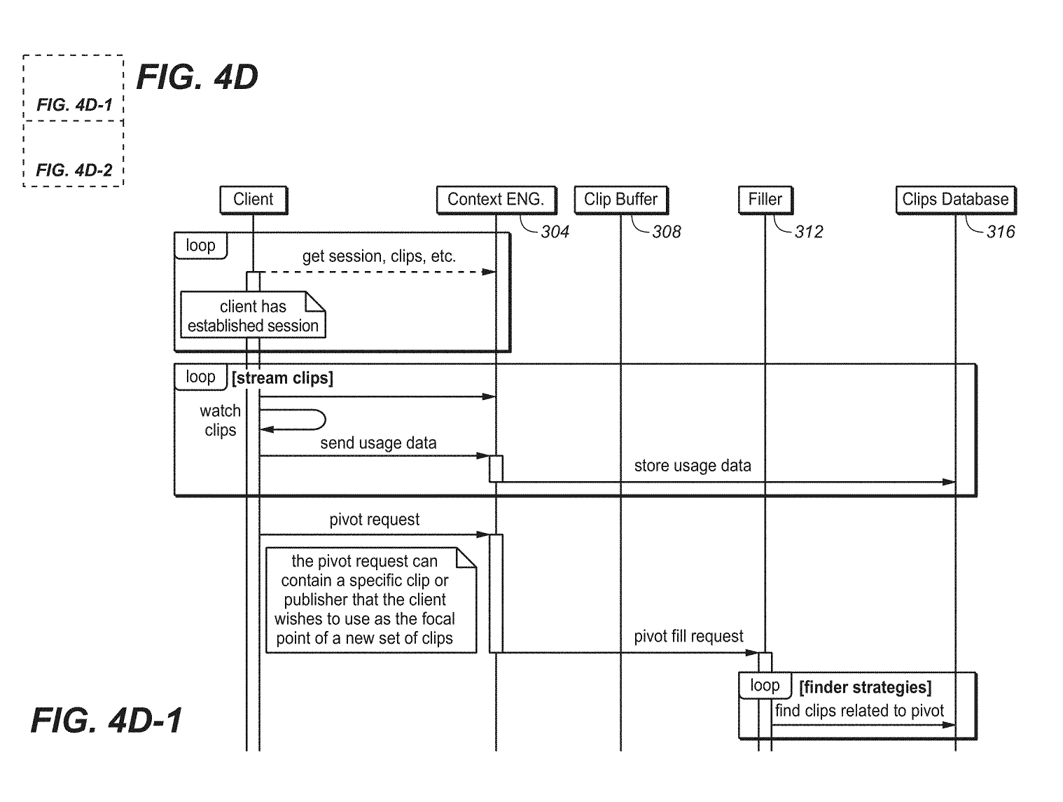

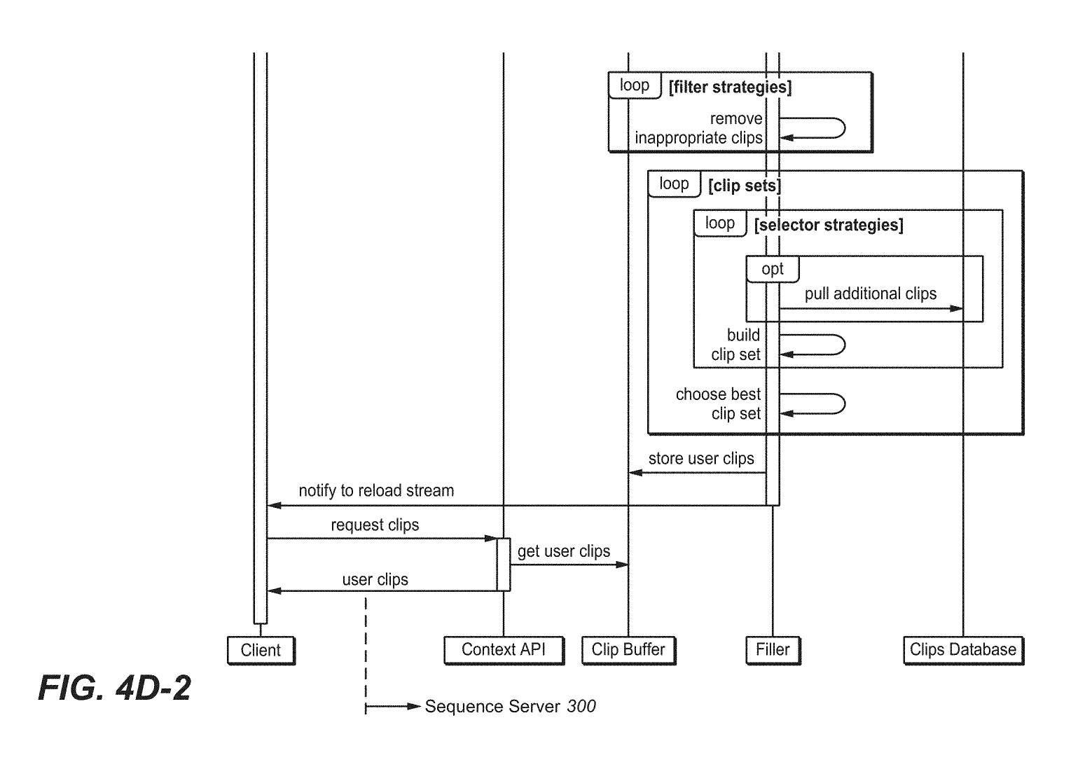

The interaction between some of the logical components of an embodiment of sequence server 300 is seen in FIGS. 4B-4D. According to the depicted embodiment, sequence server 300 comprises context engine 304, clip buffer or buffers 308, filler 312, and clips database 316. As will be discussed in more detail below, the sequence server orchestrates and organizes the retrieval of video content from a wide array of content servers 400, in conjunction with the client device or client application running thereon, hereinafter the “client.”

The sequence server interacts with the client seen at the left side of the diagram. The Context Engine (“CE”) 304 is responsible for all communication with the television computing device/client app. The CE 304 sends the personalized media to the client that was prepared by the Filler. It also receives analytics data from the client and updates the users' personal media preferences. The CE also manages the long term user context settings and geolocation information. Location is one of the pieces of information used to rank/select clips. For example, if a user is in San Francisco, it will open the possibility of them receiving locally-relevant clips (ex: news clips from KTVU, etc.). Location may come from a user's IP address used by the device or device client and/or sent to the sequence server as part of a request, or in embodiments where the client device includes GPS or other location detection functionality, it can be determined with the same. For example, location may be based on cellphone tower proximity or triangulation, or wireless router location.

The client communicates with the context engine of the sequence server and creates a session. The context engine then communicates with the clip buffer to get pre-chosen clips (e.g. from previous sessions). The context engine also issues a user fill request to the filler which then uses a number of strategies 1 . . . N to find clips from the clips database of the sequence server. Those clips are then in certain embodiments filtered using filters 1 . . . N in order to remove inappropriate clips. The remaining clips are then passed to selectors 1 . . . N to choose among the scored clips which are then stored by the filler in the clip buffer. These are the clips which are then sent back to the client with the session ID. Note that the actual frames of the videos or clips are preferably not sent by the sequence server. Although the clips may be directly sent by the sequence server, it is preferable that the sequence server sends indications of the clips, which are then retrieved using the indications. The sequence server sends a sequence of clips and/or clip playback information, wherein the clip playback information comprises at least a URL or other location indication/information that the computing device uses to then fetch the actual videos from the content servers (400). The playback information may also comprise information such as the title, author, duration, actors, and other descriptive information about the video.

As represented in FIG. 4B, the client also requests clips and sends usage data to the context engine, which then gets the user the clips from the clip buffer and returns them to the client. In response to the call from the client, the context engine stores usage data in the clips database and creates a user fill request for the filler. The filler then uses usage data and a plurality of strategies 1 . . . N to find clips in the clips database, then optionally uses a plurality of filters 1 . . . N to eliminate inappropriate clips, and a plurality of selectors 1 . . . N to choose clips and put them into the clip buffer where they are sent to or retrieved by the client for viewing by the user.

The context engine can also send notifications to the client to instruct the client to perform an action. In general, these actions could direct the client to make a call to the sequence server to fetch other clips to play, or to play a specific individual clip or receive some other kind of message from the server such as to update its system to accommodate a new UI or mood or to display a notification e.g. that another used shared the device user's clip. In this instance, a notification can be sent to the client that will trigger the client to discard the clips in the current clip playlist and perform a clip request as detailed in the previous paragraph.

### Skipping

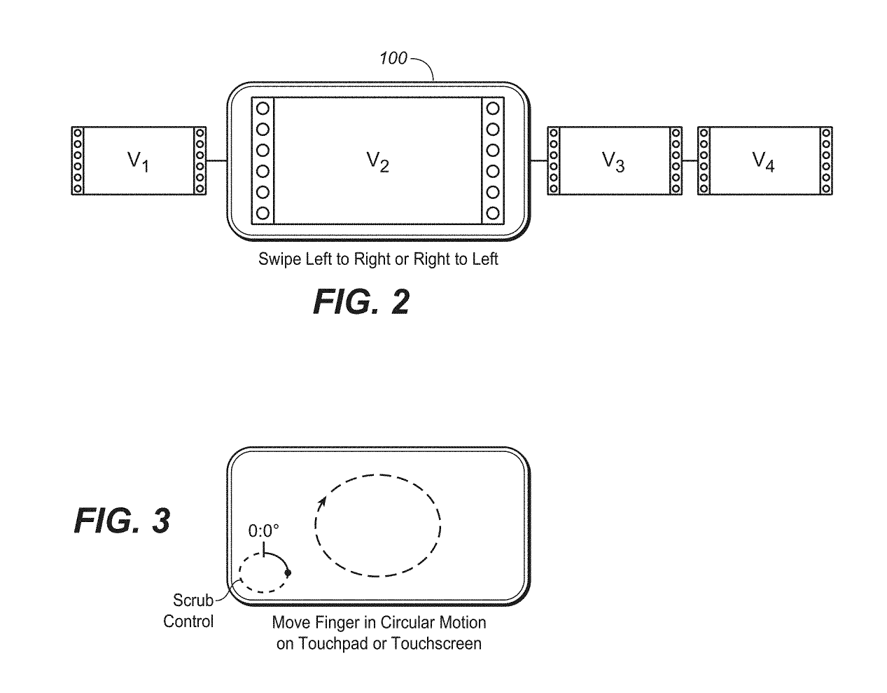

Swiping left-to-right or right-to-left on the track pad triggers a skip from the current piece of content to the next or previous piece of content, respectively. (FIG. 2) This may be reversed in certain scenarios such that a left to right swipe triggers a backwards skip and a right to left swipe triggers a forward skip.

In some embodiments, the change from one clip to another is accompanied by a transition or video effect that may or may not be interactive (i.e.: the video disappears in a direction and/or at a rate similar to the finger). In some embodiments, the change from one clip to another is accompanied by an on-screen indication of the action that was just performed (ex: “>|” or “|<” symbols).

### Scrubbing

A circular gesture on the track pad triggers a scrubbing mode, where movements of the finger (or other object) around a circle in clockwise and counter-clockwise directions result in the content playhead moving forwards and backwards in time (FIG. 3). In order to detect that the gesture is circular, there is some minimum number of radians that needs to be traversed in order to trigger scrubbing mode. In one example, scrubbing is triggered after detecting 17° (about 0.3 radians) or more of a circular arc. Note that an illustration of the scrub control and position within the current video clip is overlaid within the viewing area and displayed on the video screen. In another example, the range of radians used to determine a circular motion and distinguish it from a linear motion such as a swipe is from about 0.2 radians to about 0.6 radians. This can of course vary slightly depending on the particular implementation of the touchpad or touchscreen.

When this occurs, the playhead on the screen turns into a scrubbing control/display, providing feedback to the user that they are now controlling the current media's playback time.

In some embodiments, the radial position of the finger in the drawn circle on the track pad corresponds to the radial position of the playhead. (e.g. 90° on track pad corresponds to time at 90° on the displayed scrub control), and in certain embodiments the center point may be fixed while the user performs the gesture (e.g. at the center of the track pad).

In some embodiments, traversing one rotation on the track pad corresponds to scrubbing the full duration of the clip. Additionally, in some embodiments, movement in the circular gesture is scaled by an acceleration algorithm, so that slower movements result in more fine-grained scrubbing (ex: frame-by-frame), while faster movements correspond to high-rates of positional movement. Moving at certain rates in certain embodiments results in the audio and video content playing back at scaled rates (e.g.: causing the user to hear audio slowing down and speeding up).

For example, moving about 1 rad/s translates to approximately 5 frames/rad. Moving about 18 rad/s (i.e.: 3 full rotations/s) causes the clip to scrub at maximum speed, which is actually proportional to the length of the clip. In other words, 3 full rotations performed in under a second gets a user to the end or beginning of the clip in one second.

It is beneficial to users to be able to move accurately through time in a video, so that they can locate an event, jump forward or backwards, or simply scan for interesting visuals or for a cursory overview. One aspect that particularly enhances the user experience is a seamless and smooth transition in the rate of scrubbing. Smooth acceleration or deceleration of the scrubbing motions and accompanying change in frame advance is achieved in relation to the circular scrubbing technique according to a disclosed embodiment described below.

Since the trackpad on certain types of devices, such as remote controls or phone screens is small, rectangular or square, and doesn't provide a lot of either vertical or horizontal resolution of space, a circular gesture provides advantages as compared to other types of control mechanisms.

With a circular gesture, a user can begin the gesture at any point on the circle to represent the current position within the clip being played. This is not the case with a linear gesture on a restricted track pad or touchpad because, in that case, a user's potential movement is restricted by the surface dimensions of the track pad. For example, the beginning of a linear motion would likely be at one edge to leave room for the full swipe, the length of which is restricted by with width of the touchpad.

Further, with a circular gesture, the user can continue traversing the circle multiple times without lifting his or her finger, vs. a linear gesture, where the user's finger must be lifted, moved, and repositioned to issue multiple tracking commands.

Additionally, since a circular gesture is not space limited, acceleration can be applied at a much dynamic higher range than would be possible on a linear touchpad. In other words, slow movements in certain embodiments are used to generate very fine (frame-by-frame) progression forwards or backwards through the video, and faster movements are used to accelerate playback to several times the pre-existing rate. Such a high range from slow and fine frame by frame progression to traversing an entire clip in a single continuous motion (a rotation or two) is simply not possible with linear motions on handheld device touchscreens.

Greater detail on the physics of an acceleration gesture, according to an embodiment, is as follows. When a finger is placed on the touchpad, a gesture recognizer receives a touchdown point at [0,0], wherein the zero values for the X and Y coordinates indicate a starting point for a gesture. Regardless of the physical location of the finger on the touchpad, the operating system of a preferred embodiment of client 100 will return (location) points relative to the starting point of the gesture.

At some externally defined, irregular interval (˜1/60 s) the gesture recognizer receives additional points, relative to the original [0,0] point. For each adjacent point, an arc is calculated by taking the arctan of the two adjacent points.

To filter out noise caused by irregular movement of a finger around a circle, a history is maintained to look for consistent direction. In one embodiment, when three (or more) consecutive directions are computed, a current-direction is determined. If an anomalous direction value is computed, it is ignored, until there are again three consecutive direction values, which the system will use to note a true (not misread) change of direction. More than three consecutive directions may be used to determine the consistency in direction in various embodiments, in keeping with the size and resolution of the touchpad. In the case described here where a circular gesture is the trigger for scrubbing, the consistency is along the circumference of the circular motion established by the arc.

In order to distinguish between vertical and horizontal swipes (used to skip next/prev clip and to reveal actions), the circular gesture requires a minimum arc of movement before it is recognized. Based upon research and fine-tuning, it was determined that a 0.5 rad arc (˜30 degrees, or 28.65 degrees more precisely) is the preferable amount of arc to distinguish between a linear movement and a circular movement, although anywhere in the range of 0.3-0.8 rad arc may be used as a lower threshold for arc determination.

Once detected, the finger's velocity around the circle is used to change the rate of video scrubbing speed. More precisely, in one embodiment, the change in velocity or acceleration changes the rate of video scrubbing speed. Speed is capped at both minimum and maximum extremes in the preferred embodiment (in both forward and reverse directions).

In one embodiment, the top or capped speed is 25 rad/s, meaning that even if a user makes a circular gesture at a higher rate, the device will still use the max rate of 25 rad/s as the speed, although a range of anywhere from 18-30 rad/second may be utilized as a top capped speed. At the preferred top speed of approximately 25 rad/s, it takes two rotations around the circle to traverse the entire duration of the clip in ˜0.5 s.

Again in the preferred embodiment, the slowest threshold speed to trigger scrubbing is 0.5 rad/s, although a range of 0.3-1.0 rad/second has been determined to be suitable for a minimum threshold circular scrub speed. At 0.5 rad/s, it takes 0.25 radians to traverse one frame of video.

Between the minimum and maximum values for circular scrub speed (anywhere between the minimum and maximum ranges given above), the acceleration is scaled exponentially (preferably as velocitŷ^{1.5} but anywhere in the range of velocitŷ^{1.2-2}) from the top speed down to support similar movements across different clip durations. At its fastest speed, it is preferable to have two rotations represent the entire duration of the clip, so that, in other words, two rotations will take you from the beginning to the end of the clip or vice versa. With the constant measurement of the rotational speed, the system allows the user to quickly get past sections of a clip he wishes to pass by, but also provides accurate frame by frame control at lower speeds, simply by reducing rotational finger speed. This greatly improves the user experience as compared to prior mechanisms for moving through video clips, especially on devices with space limited touch screens or trackpads.

Further improvements and variations include an embodiment with a set fixed velocity range corresponding to scrubbing at 1× playback speed. This allows one to fast-forward/rewind at a variable rate that changes with the rate of the clip, while keeping the effects of slower movement (frame-by-frame to 1×) consistent across different duration clips.

The challenge is that it is desirable to have a fixed number of very fast rotations to get from the beginning to the end of a clip, but that using a rate of acceleration that works well for such high speed scrubbing does not work for slow speed scrubbing where fine control is desirable. For example, to achieve 3 rotations at 25 rad/s to traverse from beginning to end, different scrub time/rad values are needed for clips of different durations. For example, a short 60 s clip would traverse 60 s of clip time over 19 rad (so ˜3 s/rad), while a long clip (1 h) would have to traverse 3600 s over the same 19 rad, translating into scrubbing at ˜190 s/rad. If the same rate of acceleration was applied to both clips, the system would produce very different behavior at slow speeds. Therefore, an embodiment of the system is configured with a variable acceleration rate, or multiple discrete acceleration levels so that below a threshold (e.g. 3-5 rad/s) the traversal of time is equal across all clips, but above that threshold, the system scales acceleration based on the duration of the clip. This way, slow-motion, 1×, 2× scrubbing speeds always traverse time at the same rate, while fast speeds still get a user to the end quickly, regardless of the duration of the clip.

The flowchart of FIG. 4A illustrates aspects of playback and the interaction and coordination of the client and sequence server 300. As seen in step 410, after the client is started, the client requests to login into sequence server 300. Similarly, once the sequence server is started, as seen in step 430 it awaits a login from the client device. The client begins with counter value i=0 as seen in step 412. After the sequence server is logged into by the client, it checks if it has sufficient clips for the user, as seen in step 432. If it does not have sufficient clips, then as seen in step 434 it will refill the sequence server queue for the particular user and/or the client. The sequence server will then send a portion of its sequence server queue for the user to the client as seen in step 436.

This is also reflected in step 414 on the client side, where it is indicated that the sequence server 300 returns a content sequence with “n” content items or clips (clip references) to the client.

The client then fetches the content stream for video clip i (“V[i]”) from one of the appropriate content servers 400 in step 416.

The client then begins playing first item ‘i’ in queue as it awaits user input on the touchpad of the device, as reflected in step 418. As reflected in step 420, the video content of the clip plays until the end of the clip unless a user initiates a skip action or some other action such as scrubbing which will also deviate from normal playback. At the end of the clip or when the clip is skipped, the counter will increment to [i+1], as seen in step 422. The client will then analyze whether the current sequence contains sufficient clips in step 424, and if not, as seen in step 426, it will request additional sequencing information from the sequence server. This can be thought of a pre-fetching clips, and as discussed elsewhere, prefetching may be limited to ‘t’ seconds (z in claim) per clip to optimize bandwidth. If it does determine that it has sufficient clips it will return to step 416 and play the next clip in the sequence. Note that the variables in the claims may differ from those in this description.

As mentioned earlier, the system is specially configured to interpret movement on the touchpad or touchscreen to either skip, scrub or act on the video content be displayed. The video display computer sends a message to the sequence server to inform of an action, as interpreted from motion sensed at the touchpad. Some examples of actions and touchpad motion, are skip, scrub, play, like, boost, share, or comment. Certain actions, whether on the touchpad/touchscreen or other input device, may trigger changes to the sequence or queue; if these events are triggered, the sequence server sends a signal to the video display computer to purge unplayed clips in queue, and replace with new set of ‘n’ clips. For example, skipping quickly through multiple clips of a certain genre may cause the server to send fewer clips of that genre.

### Actions

While some of the aforementioned actions are achieved by moving one or more fingers on the touchpad, some actions may also be triggered or achieved by pressing down on the track pad (i.e.: clicking). In some embodiments, when the trackpad is pushed, the system will in response reveal a set of actions that are available to the user that can be performed on a clip or series of clips.

Examples of such actions include: “Boost” (comparable to “Like” or “Share” but without requiring specification of a recipient or group with which to share); “Report” (e.g. reporting a problem with a clip; ex: unsuitable content); “Buy” (when watching a trailer, user could upgrade to the full clip for a price); “Play More” (to get more similar content in the stream; for example by selecting the content publisher or one of it's keywords, to be specific about what qualities should be favored in subsequent clips.) The press or click type gesture is available anytime a video is playing.

In some embodiments, a clip may have only a single action that is triggered immediately with the press, while in other embodiments, a clip may have multiple actions, and the press gesture reveals the set of actions that are available, allowing the user to select between them. For example, a user may pivot away from a current group of clips and once depressed, the paths the user may take would appear on screen and allow the user to select the path. In one version, icons or other visual indication of the path will only appear so long as the user is still pressing down, and then the user can move his finger on the touchpad to highlight and select a given path and execute the pivot choice.

In some embodiments, the set of available actions for each clip may vary and will be determined and delivered by the sequence server to the client application.

### Learning

To increase the efficiency of the system, the selection of video content delivered to the user reflects the user's preferences. If the user does not like the content they are seeing, they will more likely skip over the content, and the system's efficiency comes in jeopardy. In an ideal case, the content delivered to the user is so perfectly tuned to the user that they no longer feel the need to skip over any piece of content, because every clip matches their interests at any moment.

Many prior user experiences begin by asking the user to select from a particular set of topics or genres to help jump-start the set of content that is delivered so that it is tailored to the user. This kind of experience is often frustrating to the user as it requires them to make decisions very early on, causing them to lose interest in the experience before they start using and experiencing the core features. One advantage of the present invention is that the system eliminates the set of questions that must be asked of the user, and instead understands the user's preferences based on the his interactions.

As the user interacts with the client or device (ex: watching a video clip until the end; skipping to next clip; etc.), these events are sent as feedback or a learning information stream back to the sequence server. Different interactions result in positive or negative weights based on the presumed intent of the user. For example, in certain embodiments, watching a clip past a given threshold (e.g. 50%) or all the way to or near the end is a mild positive signal that a user likes a clip, whereas a “Boost” of the clip is a very strong positive signal. Skipping from one clip to the next after more than a minimal amount of playback, when the user has seen enough to know that he would rather watch something else, e.g. after more than a threshold of 7-15 s of playback, is a strong negative signal, while skipping closer toward the end of the clip may be a mild negative or mild positive signal.

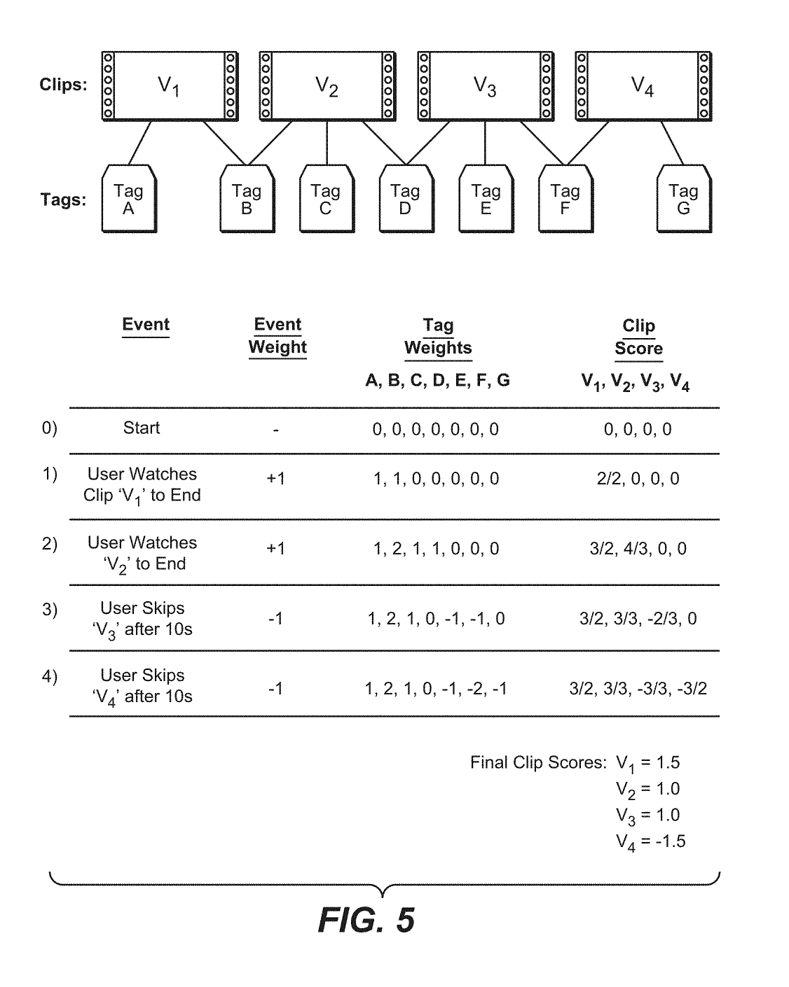

FIG. 5 shows an example of event weighting using a system of tags and tag weighting to generate scores for clips Vₓ (V₁ through V₄ illustrated). It is a simplified illustration of an exemplary scoring process or algorithm for determining what video clips will be offered to a user based upon user viewing of videos/clips.

Each clip may have one or more tags (keywords) associated with it. As user interacts with the different clips, the weights of the interactions accumulate with the associated keyword. The effect is that if a user frequently skips clips with the same keyword, that keyword will accumulate a strong negative weight. If a user frequently watches clips with certain keywords until the end, the weight of that keyword accumulates positively.

When the Filler selects clips to be placed in the Sequence Server's queue, it incorporates the weight of different keywords for different clips to determine a score for each clip. If a clip is associated with one or more keywords with positive scores, it increases the likelihood that that clip is favored for selection; If a clip is associated with one or more keywords with negative weights, the chance that clip will be selected decreases. The overall effect is to intuit a user's preferences based on their interactions, without having to ask them to tell the system about their favorite genres or topics.

In some embodiments, the system may insert “survey” clips/videos into the stream of content, allowing the user to pick between two or more items as an action.

The following clip recommendation strategies may be used together with learned user preferences or without. For example, as seen in the top half of FIG. 4B, when there is no learned user data, which may happen under certain circumstances, pre-chosen clips may be requested by the sequence server context engine. Various of the strategies (alone or in combination with each other) may also be used with usage data to provide “user clips” rather than “pre-chosen” clips for a user. User clips in this context refers to clips recommended to a user based at least in part upon prior user decisions and actions while viewing clips. While pre-chosen clips are chosen for and thus specific to a user, they, as opposed to “user clips” are not based upon learnt user data gathered from user interactions while a user viewed clips and/or was logged into a given session.

The purpose of utilizing these strategies is to provide a user with an initial stream and a number of subsequent streams available and buffered for the user to instantly switch to/between (by e.g. swiping on the track pad.)

### Clip Recommendation Strategies/Algorithms:

Clip recommendations are compiled by a series of strategies. At least three types of strategies may be employed in certain embodiments, alone or in combination with each other.

Finder Strategies query the graph database for clips which match a certain set of criteria, and score those clips relative to each other.

Filter Strategies take the list of clips created by the Finder Strategies and eliminate any inappropriate clips.

Selector strategies reduce a pre-existing or filtered list from the finders and/or filters to reduce, transform, or manipulate a list to a desired size and/or to achieve certain other desired characteristics such as a desired sequencing or ordering. For example, it is undesirable to juxtapose a very funny comedy clip right before a very serious news clip about war. While the filler strategies may have picked both those clips as relevant to the user's interests or context, the selector strategies can apply rules that further organize and order the content.

Moods may also be employed. Each mood has a configured list of strategies to use when finding and selecting clips for that mood. In certain embodiments, each finder strategy for a mood also has a weight assigned to it, which is used to normalize clip scores between strategies (and thus control the relative strength of different strategies within the mood).

For further information please refer to the source code in the appendix, which provides exemplary code for certain of the aforementioned aspects, strategies, and algorithms and is hereby incorporate by reference.

In other embodiments, each mood also has a configured list of coefficients which determine the weighting of individual clip properties when scoring, ranking, and selecting clips for that mood. The combination of strategies and scoring coefficients used for choosing clips can be configured for each mood separately. This configuration can also be machine-adjusted for an individual user, based on that user's usage patterns and preferences, or to facilitate experimental testing of new strategies, scoring coefficients, or combinations thereof.

When tasked with choosing N clips for a mood, the algorithm performs the following steps:

Execute each finder strategy with a target of N clips.

Strategies may return less than N clips if not enough were found which satisfied the criteria.

Some strategies may return more than N clips depending on the algorithm they use.

Merge the clips found by each strategy into a single list, normalizing clip scores according to strategy weight. The Strategy which was responsible for finding each clip gets captured in the clip object.

If the clip is ultimately shown to the user, the strategy gets persisted in the user-clip relationship in the graph database. A clip found by multiple strategies will receive the sum of its individual scores.

Apply each filter strategy in turn to the combined list to eliminate any inappropriate clips.

Apply each selector strategy to the remaining list to reduce, transform, or manipulate the list to the desired size and/or characteristics.

Return the filtered list for addition to the user's bucket.

In one embodiment, strategy weights are hard-coded. In another embodiment, strategy weights are data-driven, or in some cases session-driven e.g. for a given user different weighting can be used for different sessions. For example, research with the disclosed embodiments indicates that users tend to have different preferences and viewing habits on different days of the week and/or times of the day. The video delivery system, or more specifically, the context engine of the system keeps track of the day and time of viewing during given sessions, and this information is also used in certain embodiments in the weighting and selection of clips. For example, a user may tend to favor a certain attribute or characteristic or set in the morning and a different set of attributes or characteristics in the evening. As a further example, a user may favor watching news programs on Monday morning and other types, genres or moods of programs on weekend evenings, which may for example come from a different set of providers.

In another embodiment, weights are applied to clip attributes by selectors (rather than by the finders alone), when deciding which (found) clips to select. Some selectors have several criteria they are applying to e.g. build a set. For example, a selector may attempt to build a set not only with clips supplied by a variety of providers, but also with multiple other attributes such as genre, actor subject, social relevance (ex: grouping based on who watched the video), visual style (ex: dark, bright, etc.), topic, location, or the presence of explicit/sexual/adult content. When a selector has multiple clips to select from within a certain criterion, clip ranking/scoring using weights is how the decision is made between multiple clips that satisfy the same criteria.

Some exemplary selectors, such as a selector that will be used to provide a sequence having a mix of clips from different providers (“Provider Mix Selector”), one that provides a sequence of clips within the same genre (“Genre Selector”), and one that selects provides a sequence of the highest scored clips (“Score Selector”) are explained below.

“Provider Mix Selector” groups found clips by provider then, as long as there are clips from at least two providers, takes the highest-scoring clip from each, then repeats this until it has chosen enough clips for a set.

“Genre Selector” takes the highest-scoring clip, then looks for other clips with the same genre, and takes the highest-scoring ones until it has chosen enough clips for a set. (A genre is a set of set of related tags that curators can configure within a mood. Each mood can be configured with any number of genres.) If there aren't enough, it throws away the first clip and tries again with the second-best clip, and so on.

“Score Selector” takes the N highest-scoring clips to make a set. It is used as a fallback selector in certain embodiments should the more sophisticated selectors fail to generate a sufficient or acceptable set.

“BarelyWatched” finds clips this user saw once at least 24 h ago, and skipped in under a threshold of, for example, 3-5 s. As this is a minimal time frame to watch a clip, it is not taken a strong negative and in some instances considered a neutral event in embodiments where weighting is changed based on viewing duration before skipping to another clip.

“BestRatedDecay” finds clips with best ratings after an aging decay function is applied.

In one embodiment, the aging decay function may be represented by the following formula:

$$d \vert = r \cdot ( \frac{arctan ( - 2 \cdot ( t - 4 ) )}{π} + 0.5 ) ,$$

. . . where d=decayed rating, r=original rating, and t=age of clip (in days).

For a clip with a rating of 5, a graphical representation of the rating decay is illustrated in FIG. 11. FIG. 11 shows the decay over time, in days. As can be seen, the rating rapidly decreases at about day 3 and stabilizes at a low value from about days 6-7 onward.

While a preferred embodiment utilizes the above mentioned arctan decay, other embodiments utilize a linear decay function, wherein the clip rating goes down by a fixed amount every day. In yet other embodiments, an exponential decay formula is utilized to govern the decay rate of the clip rating. Alternatively a half life (the point at which the clip has 50% of its rating) may also be utilized and set to govern the change in rating over time.

“BestRatedRandom” finds a random subset of the best-rated, most-recent clips.

“BoostedTags” finds clips containing tags which were present on other clips boosted by this user.

“LocalCity” finds clips containing the “local” tag plus one or more tags for the user's local city.

“MoodGenres” finds clips specific to the configured genres for the mood.

“MostPopular” finds clips which are popular on the provider's platform (e.g. using likes/comments on Facebook).

“MostRecent” finds clips which have been ingested most recently.

“MostWatched” finds clips which are most watched by other users similar to this user.

“PreviouslyBoosted” finds clips this user has watched and boosted.

“PreviouslyWatched” finds clips this user has watched and reacted positively to.

“Random” finds random clips which this user has not seen.

“TopicMostRecent” finds the most-recent clip matching each configured topic tag.

“WatchedTags” finds clips containing tags which this user prefers.

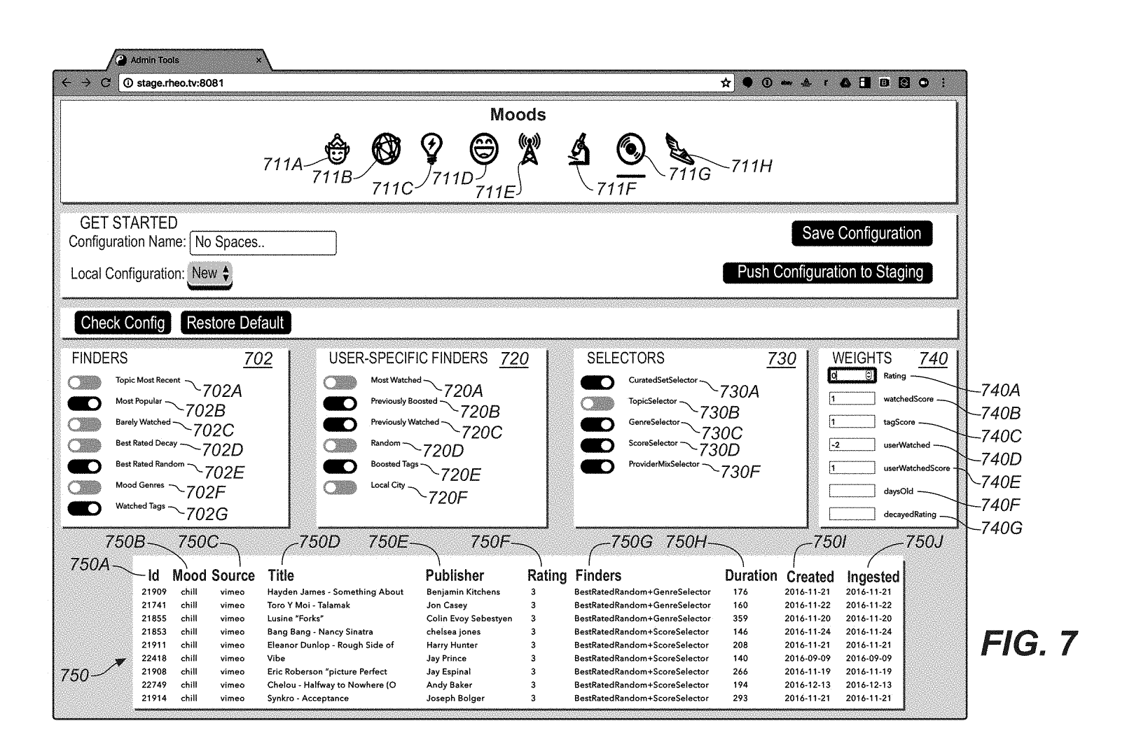

Examples of moods are given with respect to FIG. 7, described in further detail below but are as follows: 711A—Jingle, a Christmas or seasonal holiday mood; 711B—Pulse, a user stream covering all moods; 711C—Spark; 711D—Laugh; 711E—Inform; 711F—Inform; 711G—Chill; and 711H—Move.

### Learning Recommendations:

As users interact with the application, and the application captures data on those interactions, the system learns about the user in order to make better recommendations.

User interaction data is stored in the graph database in the form of relationships between user and clips (indicating clips the user watched, boosted, etc.), and between user and tags (indicating tags the user prefers or dislikes).

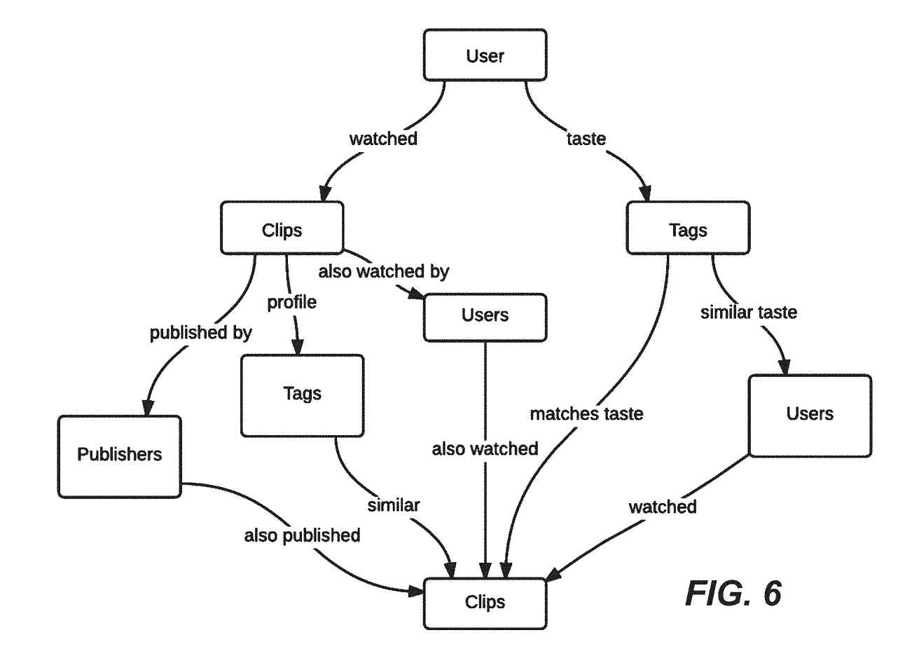

Starting from these two types of relationships, there are five relatively simple paths that lead to recommendable unwatched clips depicted in FIG. 6. The following enumerated points describe the paths/strategies shown in FIG. 6.

The path labeled User->Tags->Clips depicts a high level strategy for finding clips that match the user's preferences.

The path labeled User->Clips->Tags->Clips depicts the high level strategy for finding clips that are similar to clips the user has watched. This strategy overlaps with the strategy for finding clips that match the user's preferences, but is used to find clips for newer users where there is insufficient data for a user to match the user's preferences.

The path labeled User->Clips->Publishers->Clips depicts the high level strategy for finding clips for retrieving other clips from publishers whose clips the user has watched.

The path labeled User->Tags->Users->Clips depicts the high level strategy for finding clips watched by other users with similar preferences to the user.

The path labeled User->Clips->Users->Clips depicts a strategy for finding clips watched by other users who have watched the same clips as the user. This strategy is similar to the “similar users” approach, but differs in how the similar users are identified.

### Identifying Similar Users

Certain Strategies attempt to find clips based on other users who are most similar to the current user. Similar users are determined and scored through two methods: by relationships to common tags, and by common clips watched.

### Common Tags

Common tags may be used as or in part of a strategy and algorithm in order to determine what clips to present to a user. This involves finding and using common tag relationships between the current user and other users.

In one embodiment this is achieved by multiplying the weight property (can be positive or negative) of the relationships between tags/users.

The next step involves summing the products together into a score for the other user. After this the system will return the N users with the highest scores, excluding any which are negative.

### Common Clips

Common clips may be used as or in part of a strategy and algorithm in order to find common watched-clip relationships between the current user and other users.

This involves multiplying the reaction property (can be positive or negative) of those relationships and then summing the products together into a score for the other user. After this the system will return the N users with the highest scores, excluding any which are negative.

The two lists of the users are merged; users present in both lists receive a final score which is the sum of the two individual scores. The top N users (by score) are kept, and the final list is cached in the session data for use by the strategies.

Another strategy utilizes a least squares approach for scoring similar users. This strategy takes a user under consideration and reduces that user's taste (or distaste) for each tag and publisher to either −1 (distaste), 0 (neutral), or +1 (positive taste). Then this user's tastes are compared to those of other users by calculating the difference the two user's tastes on common tags/publishers, then squaring that to produce either 0 (the users have the same taste), 1 (one user neutral, the other positive/negative), or 4 (users have opposite taste). The mean of the squares across all tags and publishers is a floating-point number between 0 and 4 which indicates how different the two user's aggregate tastes are; the users with the lowest value are the ones that are most similar to the user under consideration.

### Finder Strategies

Finder Strategies query the graph database for clips which match a certain set of criteria, and score those clips relative to each other. In the preferred embodiments, the employed Finder Strategies (with the exception of Previously Watched) explicitly exclude clips which have already been watched by the user in a given period of time or the same session.

### BestRated

The BestRated Strategy identifies unwatched clips which have the highest star ratings (by curators) and are most recent. It returns the top N clips ordered by highest rating, followed by most recent timestamp, with rating used as the score.

### MostPopular

The MostPopular Strategy attempts to identify unwatched clips which are popularity “outliers” relative to other clips from the same publisher.

It does this as follows: 1. calculate the average likes-per-day (LPD) and comments-per-day (CPD) for each clip; 2. compare LPD and CPD with the mean for all clips of that publisher, and determine the number of standard deviations above the mean; 3. multiply the two numbers together to get a score; and 4. return the N clips with the highest scores, excluding any with a score below a threshold e.g. 1.0 in this example.

See the table below for an illustration of how the score is calculated.

| Clip | Publisher Overall | Score |
|---|---|---|
| Likes/day: 20 | Likes/day/clip: | LPD score: (20 − 20)/10 = 0 |
| Comments/day: 10 | Mean = 20 | CPD score: (10 − 10)/5 = 0 |
| | Standard | Score: 0 * 0 = 0.0 |
| | deviation = 10 | |
| Likes/day: 30 | Comments/day/clip: | LPD score: (30 − 20)/10 = 1 |
| Comments/day: 15 | Mean = 10 | CPD score: (15 − 10)/5 = 1 |
| | Standard | Score: 1 * 1 = 1.0 |
| | deviation = 5 | |
| Likes/day: 55 | | LPD score: (55 − 20)/10 = 3.5 |
| Comments/day: 20 | | CPD score: (20 − 10)/5 = 2 |
| | | Score: 3.5 * 2 = 7.0 |

### MostWatched

The Most Watched Strategy attempts to find unwatched clips which have the highest level of engagement among users who are most similar to the current user.

In one embodiment, a cached list of similar users is maintained so that it is readily available. The cached list is maintained in the RAM memory of sequence server 300. To create a sequence based at least in part on the most watched clips, the system begins by using the cached list of similar users according to the following process:

1. Find clips watched by similar users;

2. From the user-clip relationships, calculate a score for each clip as sum(reaction)+2*likes+3*shares; and

3. Return the N clips with the highest scores.

### MostRecent

The Most Recent Strategy identifies unwatched clips which were posted most recently. It simply returns the top N clips ordered by the most recent timestamp, scored by recency.

### MoodInform

The Mood Inform Strategy is a special case for the Inform Mood, which finds the most recent clips with tags that match each of a configured list of Genres, e.g.:

A. #breakingnews, #news;

B. #investigative, #analysis, #interview, #opinion; and

C. #comedy, #satire.

Each Genre is also configured with a maximum age for which clips can be considered valid, and a score for the Genre. Starting with the first Genre: find all clips newer than the maximum age with at least one of the tags for that Genre; apply a score for the Genre to clips found; and repeat using the next Genre until at least N clips are found.

### Random

The Random Strategy simply chooses N unwatched clips and assigns them random scores. It only executes when preceding Strategies fail to find (at least) the desired number of clips.

### Previously Watched

The Previously Watched Strategy attempts to identify clips which the user has already watched, but which are now appropriate to show again.

In one embodiment, it does this as follows. It first finds clips watched by the current user. Then, from the user-clip relationships, it calculates a score for each clip as sum(reaction)+2*likes+3*shares+weeksSinceWatched. Then it returns the N clips with the highest scores.

### Filter Strategies

Filter Strategies take an ordered list of clips created by the Finder Strategies and reduce, manipulate, and/or transform it into an intermediate or final list of clips used to fill the session bucket, as discussed at many points in this application. In one embodiment, filters are primarily used to remove clips that were surfaced by the finder strategies but cannot be served to the particular user. For example, geographic restrictions imposed by the provider, time-of-day filtering of explicit material, etc. In such an embodiment, final clip selection and sequencing (from amongst the surfaced clips) is done by the selector strategies.

FIG. 7 illustrates a filler configurator according to an embodiment. This is an administrator interface used herein to illustrate, in an over-simplified fashion, how changes to various parameters will result in a variation in selection of clips and sequences and/or potential sequences of clips eventually presented to the user. Moods 711A-H are shown at the top. These are example moods and it should be understood that other moods exist and that new moods can be created over time. The example moods are as follows: 711A—Jingle, a Christmas or seasonal holiday mood; 711B—Pulse, a user stream covering all moods; 711C—Spark; 711D—Laugh; 711E—Inform; 711F—Inform; 711G—Chill; and 711H—Move.

Finders 701 are shown at the center left of the interface. Each of the example finders can be turned on or off and doing so will result in a different set of clips 750 that are generated as a result. The example finders shown are: “Topic Most Recent” 702A; “Most Popular” 702B; “Barely Watched” 702C; “Best Rated Decay” 702D; “Best Rated Random” 702E; “Mood Genres” 702F; and “Watched Tags” 702G. FIG. 7 also illustrates user specific finders 720, example of which are shown to include “Most Watched” 720A; “Previously Boosted” 720B; “Previously Watched” 720C; “Random” 720D; “Boosted Tags” 720E; and “Local City” 720F. FIG. 7 also illustrates some exemplary selectors 730, which includes: “Curated Selector” 730A; “Topic Selector” 730B; “Genre Selector” 730D; and “Provider Mix Selector” 730F.

A system of weighting 740 is also employed. In certain embodiments the weighting is employed to weight the finders or finder strategies, such as the user specific finders, while in others it is employed to weight the selectors. In yet another embodiment weights may be applied to both finders and selectors. In this example configurator screen, weights are shown applied to each of “watched score” 740A, tag/score 740B, “user/watched” 740D, “user/WatchedScore” 740E, “daysOld” 740F, and “decayedRating” 740G.

Results area 750 illustrates the particular set of clips gathered by the specific combination of finders 702, user specific finders 720, selectors 730, and weights 740, as configured. For a change to any of the granular finders, selectors and weights a different set of clips will be produced, and eventually sequenced. As seen in results area 750, an ID 750A, Mood 750B, Source 750C, Title 750D, Publisher 750E, Rating 750F, Finders 750G, Duration 750HJ, time created 750I, and time Ingested 750J are provided for each of the listed clips.

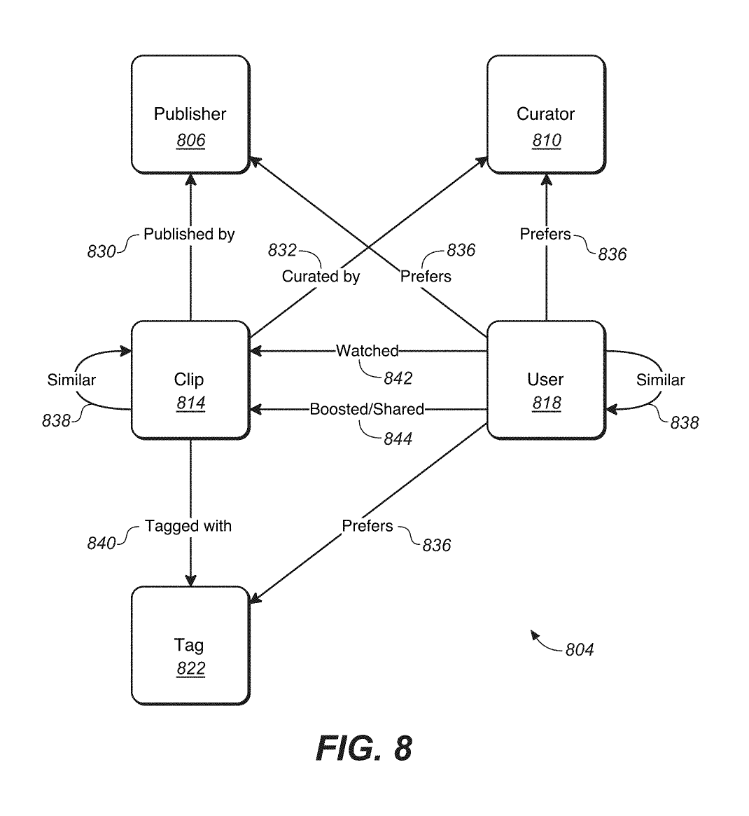

FIG. 8 is an illustration depicting clip objects and actions relating to clip objects and shows a basic object model/process 804 used for clip selection by certain of the embodiments. It should be understood that variations to this model/process are contemplated and that the various embodiments are not limited to the specific model or process depicted in FIG. 8. At its core is the clip object 814. Each clip corresponds to one video asset in the system and is associated with a publisher 806 who originally posted/created the content. Each clip is also associated with one or more tags 822 which describe the clip's content, and with a curator 810 who was responsible for ingesting the Clip into the system, rating it, and assigning the Tags 822.

The User object 818 represents a person using the system. As the person uses the application to watch clips, relationships are created between the user and each clip, capturing how the individual engaged with the content, e.g. how much of the clip they watched, whether they boosted/shared it, etc. The relationships are indicated by the lines connecting the various objects. For example, the relationships comprise: “published by” 830; “prefers” 836; “tagged with” 840; “watched” 842; “boosted” or “shared” 844; and

Relationships are also created (or updated) between the user and the corresponding publishers, tags, and curators, based on how the clip performed for this user. The aggregate of these relationships reflects the user's taste profile. Over time, as more data is gathered, the accuracy of the taste profile improves.

These relationships are then leveraged when deciding what content to serve to the user in the future. The strength of the relationships to common tags, publishers, and curators between user and clip is used to predict how an unwatched clip will perform with the user.

A clip's score and related ranking is the sum of N numeric properties of the clip, each multiplied by the weight assigned to that property or attribute. Expressed as an equation, the score is calculated as follows:

$$score = {\sum }_{i = 0}^{N} {property}_{i} \cdot {weight}_{i}$$

Some clip properties (also referred to as “attributes” herein) have the same value for all users and are relatively static, e.g.: rating (set by curators); ingested (timestamp when the clip was ingested into the system).

Some clip properties have the same value for all users but are dynamic and can change over time, e.g.: daysOld (grows based on age of clip in the system); and decayedRating (value of rating which decays based on age of clip in the system).

Some clip properties are different for every user, and are calculated based on that's user's profile, e.g.: tagScore (how strongly the clip's tags match the user's taste profile); and publisherScore (how strongly the user has engaged with this publisher's clips).

The set of weights applied to clip properties can be variable based on the user, and can be considered to be part of the user's taste profile.

For example, User A might prefer to watch the newest clips regardless of source or subject matter. User A might thus have a higher weight assigned to the daysOld property, and a lower weight assigned to the tagScore and publisherScore properties. Meanwhile, User B might prefer clips with narrower subject matter regardless of age, which would result in a lower weight on daysOld and a higher weight on tagScore and publisherScore.

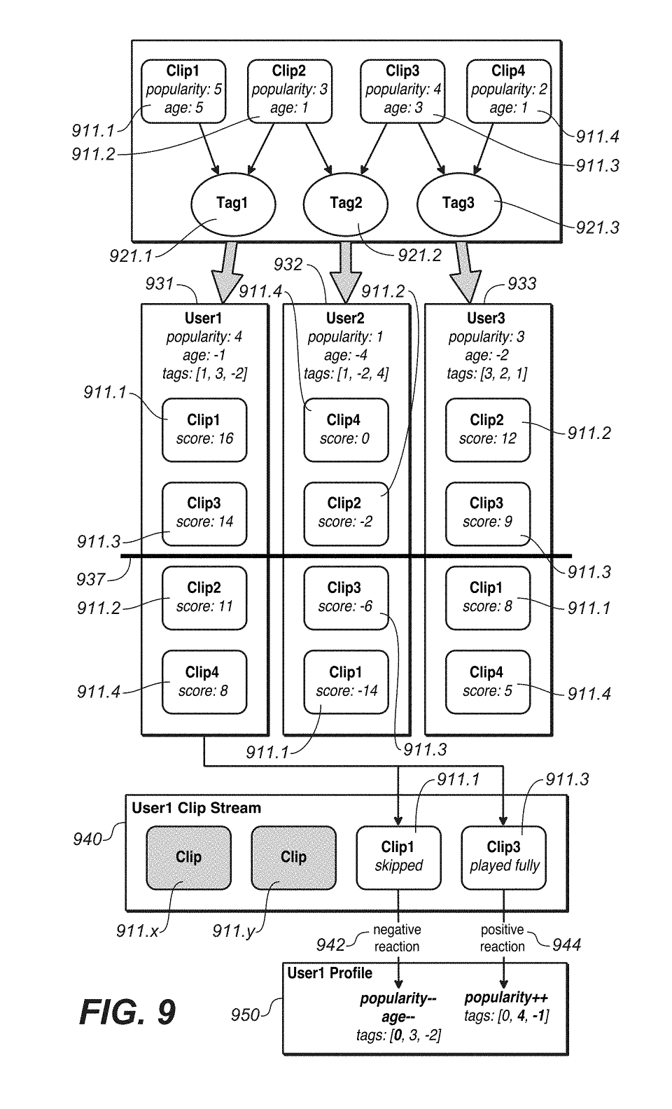

FIG. 9 is an exemplary illustration of clip ranking. It should be understood that the figure and explanation are simplified material for explanatory purposes, and that the preferred algorithm and process relating to clip ranking are more complex and contained in the attached source code appendix, which is an integral part of the specification and is hereby incorporated by reference for all purposes.

As seen in FIG. 9, a plurality of candidate clips, represented here by clips 1 . . . x, enumerated as clips 911.1, 911.2, 911.3, and 911.4 are surfaced or in other words selected by various finder and/or selector strategies, as discussed earlier. As can be seen, each clip has a number of attributes, only two of which are shown in this exemplary figure: popularity and age. A plurality of different tags are also utilized by the system in the process of determining what video clips will eventually be provided to the user. Three tags are illustrated in this diagram representing some of the plurality of tags 911.1 . . . x. Each clip is associated with a set of tags that describe aspects of the content within the clip.

Each user has a profile, and users 1-3, are shown in the diagram and enumerated as users 931, 932, and 933 respectively. Each user's profile captures his affinities using a weighting of clip attributes and tags. Again, the exemplary attributes illustrated in FIG. 9 are popularity and age. Popularity in this context is used to indicate the user's affinity for popular clips. A user who has a strong affinity for popular clips will have a high popularity attribute weighting whereas a user with a low affinity for popular clips will have a low popularity attribute weighting. Of course this may be reversed and any scale may be utilized.

Clip selector strategies score and rank candidate clips based on the user's profile weights, and build a set with the best clips for a particular user based on the information (e.g. attributes, tags etc.) in the user profile. Other criteria may also be used by or incorporated into the selector strategies as discussed above. For example, a selector may be configured to supply clips from a variety of publishers or sources, even if it would otherwise highly rank and thus generate a set of clips from the same publisher. Other example criteria include: grouping clips into a set based on common genre, tone, or subject matter; providing a hand-curated set which is augmented or customized for the particular user; showcasing a set of personalized clips from a highly-rated publisher or provider.

Looking at user three, shown to have user profile 933, it can be seen that user three attributes include a popularity attribute at level three, and an age attribute at level negative two. User three profile 933 also contains or is associated with tags [3, 2, 1]. Scoring of clip two for user 3 will now be described, and reference to profile 933 at the right side of FIG. 9 should be made. The score for user three, clip two computes to twelve (12) according to this simplified example depicted in FIG. 9. This is broken down as follows: popularity (profile x clip popularity rating) 3×3=9; age [−2]×1=[−2]; Tag1, 3×True=3; Tag 2, 2×True=2; Tag 3, 1×False=0; total score=12. As another example, user 3 scoring of clip 3 would be calculated as follows: popularity 3×4=12; age [−2]×3=[−6]; Tag1, 3×False=0; Tag 2, 2×True=1; Tag 3, 1×True=1; Total score=9.

As can be seen, especially when comparing users one, two and three (931, 932, and 933 respectively), a clip will have a different score for a user, depending on the user characteristics maintained in the user profile. For example, the same clip, e.g. clip 1 has a score of sixteen for user one, but a score of zero for user two, and a score of twelve for user three.

The selected clips are added to a user's clip stream 940. In this example, clips 1 (911.1) and 3 (911.3) are added to user 1 clip stream as they are above a certain threshold score 937. As a user interacts with clips in his stream as he watches them, user reactions are judged and used to adjust the user's profile for future fill requests. Although positive actions (e.g. liking, sharing, or boosting a clip) may be used to adjust the users profiles, in many embodiments user profiles may be adjusted based simply on monitoring user watching habits in a passive way (without need for specific indications of liking, sharing or boosting etc.).

For example, as seen a the bottom of FIG. 9, modified user profile 950 is provided to indicate that because clip 1 (911.1) was skipped by the user, this is considered a negative reaction (shown as 942) and that the popularity and age weightings of the attributes in the user profile are reduced accordingly. Conversely, a positive reaction (shown as 944) in certain embodiments is associated with playing a clip past a satisfaction threshold (e.g. past 50% or more of the clip or fully to its end, with or without including any credits), as illustrated in FIG. 4 with regard to playing clip 3 (911.3) to its end. In this case, the positive reaction 944 results in a weighting change of the popularity attribute in modified user 1 profile 950. Looking again at user 1 profile 931, the tags are listed as [1, 3, −2] which is an indication of tag weighting. In this example where three tags are illustrated, for user 1, tag 1 has a weighting of 1, tag 2 has a weighting of 3, and tag 3 has a weighing of [−2]. Thus the negative reaction 942 that user 1 had to clip 1 results in the tag weight for user 1 clip1 going down from 1 to zero. The amount and scale of the reduction may be greater than one and also need not be linear as shown in this simplified illustration. For example, a sequence of three consecutive positive reactions could cause the score of a tag to increment by 1, then 2, then 4, in effect adding greater momentum to tags that are consistently scoring positively for this user. The opposite could be done for negative reactions, to more aggressively down-rate those tags and clips carrying those tags to be downgraded. Similarly, the positive reaction of user 1 to clip 3 results in the user 1 score of [−2] for tag 3 improving to [−1]. The modified tag weightings will, as mentioned, be used for future fill requests.

### Clip Loading

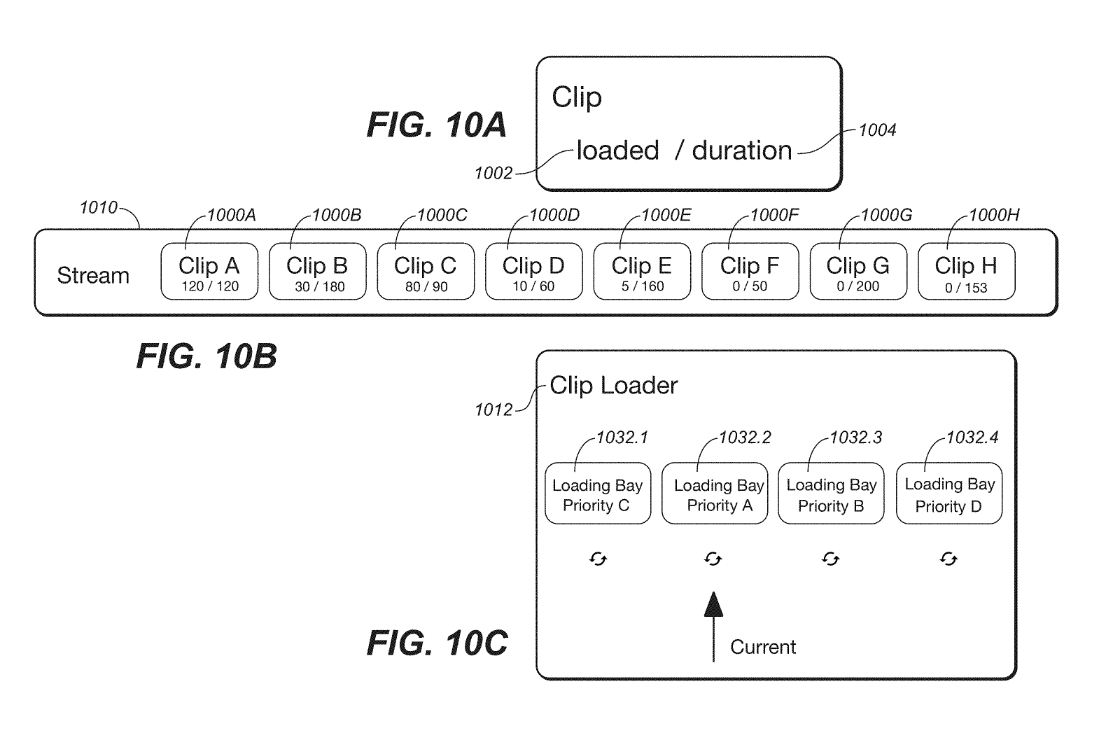

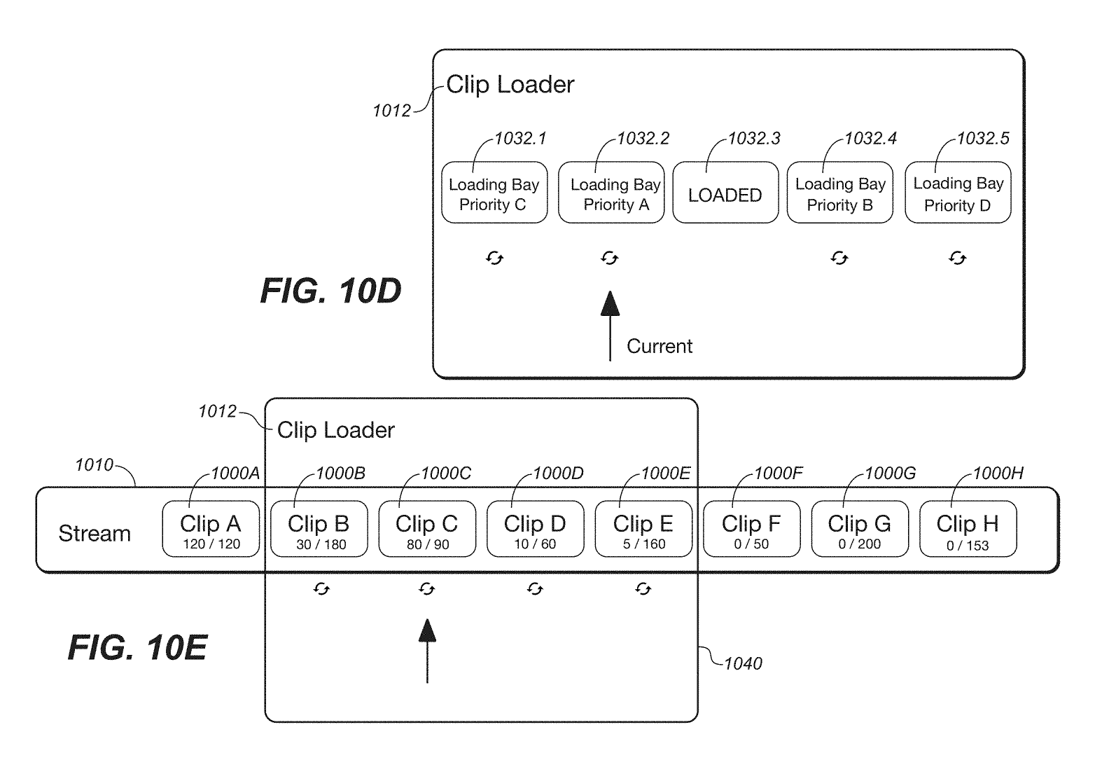

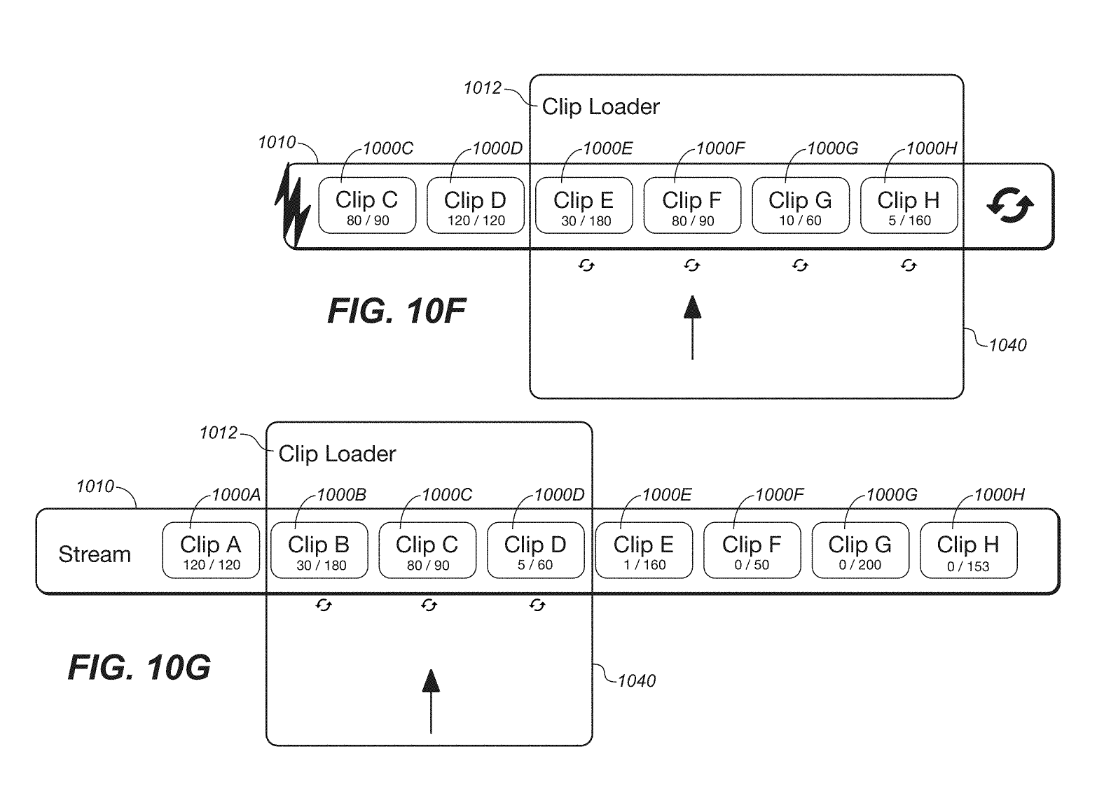

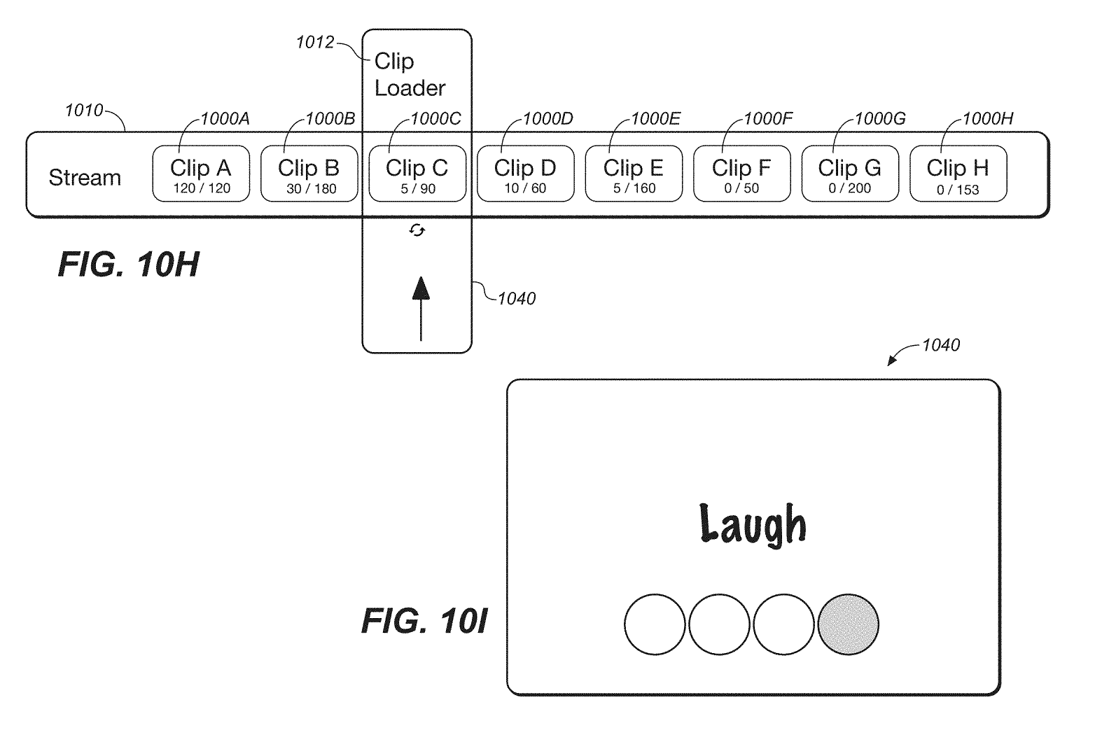

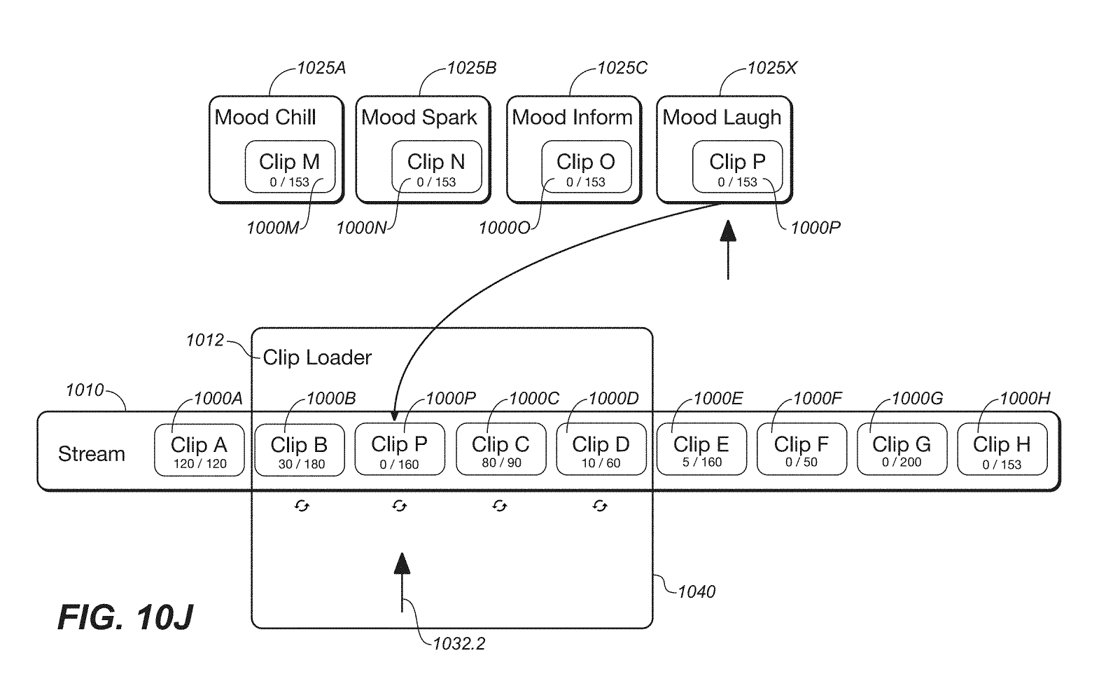

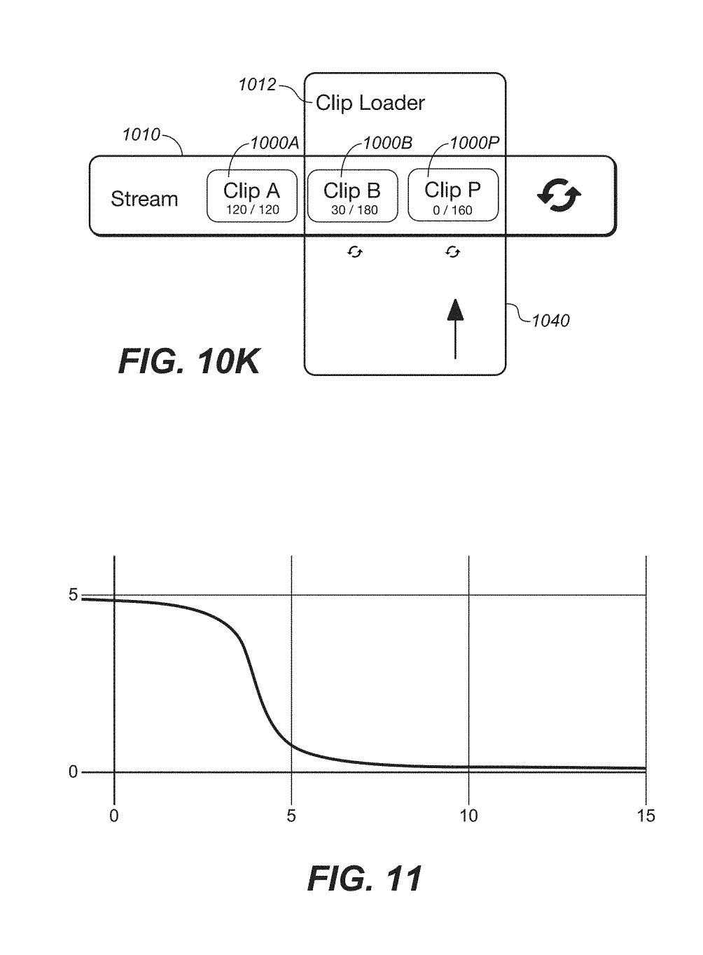

FIGS. 10A-10K depict aspects of clip loading. Clip loading is primarily handled by the client device, although aspects are coordinated with the larger system in conjunction with the sequence server.

As mentioned previously, a clip represents a single video and comprises information used to display the video (in addition to the frames of the clip itself). For purposes of loading clips at the client, two important aspects of the clip are “loaded,” shown as item 1002 in FIG. 10A, which is the amount of the video that has been buffered, and “duration,” which is the total length of the video, shown as item 1004 in FIG. 10 and throughout FIGS. 10A-10K.

A Stream, depicted as item 1010 in FIG. 10B, is an ordered array of clips that may be displayed by the client on the associated screen. In one embodiment, there is only one instance of a stream on the client. As can be seen in FIG. 10B, the stream lists several clips A-H, depicted as items 1000A-1000H respectively. Again, the amount loaded and the duration is shown for each clip.

Moving to FIG. 10C, the clip loader engine 1012, also referred to simply as the clip loader, allocates system resources towards buffering clips in the stream, e.g. stream 1010. It may buffer one or more clips concurrently depending on the clip's position and system resources. Buffering priority is given to the “current” clip first then to the surrounding clips.

In this example depicted in FIG. 10C, the clip loader 1012 has determined that the optimal number of concurrent buffering clips is four (4) and has allocated loading/buffering bays 1032.1-1032.4 accordingly. It should be understood that this is merely and example and the system may determine that the optimal number of clips to load is as low as one or as great as twenty or more. The current clip is given top priority, priority A. The upcoming clip has been given priority B (loading bay 1032.3) and the previous clip has been given priority C (loading bay 1032.1) since it has not completely loaded. Although the passed clip shown in loading bay 1032.1 has already been viewed, there is a reasonable possibility that the user will flip back to it, so the clip loader will continue to buffer it. Priority D is assigned to the second clip from current shown in loading bay 1032.4. If the passed clip is fully buffered, the second from current is given priority C and there is no priority D (not shown).

As seen in FIG. 10D, if an upcoming clip is fully buffered, such as the clip in loading bay 1032.3, the Clip Loader will expand to include the next clip and begin buffering that clip, as illustrated by the addition of loading bay 1032.5, where the clip is loading in the bay is given priority D.

FIG. 10E illustrates implementation of a clip loader 1012 with a sliding window 1040. Sliding window 1040 can slide along stream 1010 so that different clips are encompassed within the window 1040. The Clip Loader 1040 overlays a sliding window on the stream that will expand or contract based on network bandwidth and preloading health of the clips queued for playback. More specifically, the window expands and contracts based on network bandwidth and the health of the clips that are being preloaded. If the current clip has sufficient content preloaded to ensure that playback will not stall, then the window is expanded to incorporate adjacent clips. If network bandwidth is insufficient to keep up playback while it also preloading other clips, then the window contracts to reduce the number of clips being preloaded. In best case health conditions, e.g. where the bandwidth and processing speed exceeds buffer usage for playback, the system preloads three or more clips before and three (just viewed or skipped, at least in part) clips after the current clip. In worst case health conditions, e.g. extremely tight bandwidth and processing conditions, the window does not preload anything more than the current clip.

The position of the window is preferably anchored on the current clip. Under usual circumstances the window will stretch from one clip passed and two clips ahead of the current clip, although as mentioned previously it may encompass more or less clips depending on the bandwidth of the connection and other system conditions. In the example shown in FIG. 10E, sliding window 1040 encompasses clips B-E (1000B-1000E) and is anchored on clip 1000C.

As seen in FIG. 10F, when the window's upcoming edge moves close to the end of the stream 1010, a request is made (by the clip loader) to the sequence server for more clips.

As seen in FIG. 10G, if the current or next clip is buffering slowly the overlay window will contract to have fewer buffering bays 1032.x so more bandwidth is available to higher priority clips. Variable window sizing adds flexibility in diverse environments. In the example shown in FIG. 10G, the window has been down sized to include only three loading bays.

Moving on to FIG. 10H, if buffering of the current clip is slow the overlay window 1040 will contract so that only the current clip 100C allocated a loading bay and is buffering. When the current clip is sufficiently buffered the window will expand again to continue buffering the upcoming clips 100D-H. In this bandwidth constrained scenario, when the user scrubs though a video the clip loader 1012 will immediately contract the overlay window 1040 such that only the current clip is buffering so that all available resources are allocated to buffering unloaded parts of the clip that the user scrubbing or scrolling indicates may be accessed shortly.

An embodiment of the system comprises a clip loader with pre-emption functionality. As mentioned earlier clips are also grouped by moods by their attributes, and a user may select to watch clips of a certain mood. When a mood is selected for playback, the user's tailored content stream may be interrupted and replaced with a clips corresponding to the selected mood, or clips of a corresponding mood may be weighted higher in the user's sequence selection process and interwoven with other clips over time. In the case where a new mood is selected or another action requires pre-emption of a previously arranged and provided to the client sequence, loading bays and buffers are re-allocated. As shown in FIG. 10I, a user may for example change gears and decide to watch clips that make him laugh by selecting the “laugh” mood. These clips are normally not in the stream 1010. As seen in FIG. 10J, numerous moods 1025A-X are available to choose from and each mood will have a series of clips associated with it. For the sake of simplicity each mood 1025 is illustrated with only one clip 1000 therein. In the example depicted in FIG. 10J, clip 1000M is shown in mood 1025A (e.g. chill), and clip 1000N is in mood 1025B (e.g. spark), clip 1000-O is in mood 1025C, and clip 1000P is in mood (e.g. laugh) 1025X. As another example where pre-emption comes into play, a clip or sequence of clips may have multiple branch points. In one embodiment, one action a user can perform on a clip is to see its publisher or a set of topics associated with that clip. The user may then pivot to select either the publisher or one of the topics for further viewing in which case the aforementioned preemptive preloading functionality will also be utilized.

When the client is in the mood selection mode, the “current” clip in the stream, the one in the “priority A” loading bay (represented by the arrow labeled 1032.2 in FIG. 10J) is preempted by the currently selected (but not yet chosen) mood so that its first clip of the mood, in this example clip 1000P, begins to buffer. As the user selects other moods, the newly selected mood clip is placed in the priority A loading bay. In other words, clip 1000P pre-empts the previous sequence of the clip loader, and in particular is shown pre-empting clip 1000C, which otherwise would have been in the priority A loading bay 1032.1.

When the mood is chosen the system ensures that the first clip of the mood is in a state where it can be immediately played. In FIG. 10K this is represented by clip 1000P. All (previously) proceeding clips (1000C-H) are truncated from the Stream and a request for new clips within the chosen mood is made to the sequence server.

While the invention has been particularly shown and described with reference to specific embodiments thereof, it will be understood by those skilled in the art that changes in the form and details of the disclosed embodiments may be made without departing from the spirit or scope of the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A system for providing a continuous uninterrupted stream of video from content servers to a remotely located user, comprising:
a sequence server configured to communicate with a video display device of the remotely located user, the sequence server configured to:
generate a first user specific sequence of streaming videos tailored to the user, the first user specific sequence comprising playback information for x videos, wherein x is greater than 3 but less than 30;
transmit a first subset of the first user specific sequence of streaming videos to the video display device, the subset comprising playback information for y of the x videos and causing the application to place at least z seconds of rendered content into a buffer of a random access memory of the video display device for each of the subset of y of the x videos, wherein y is not less than 3 and z is not less than 10; and
upon a determination made based at least in part upon playback of the first subset, generate a second user specific sequence of streaming videos tailored to the user, the second user specific sequence excluding all members of the first user specific sequence.

2. The system of claim 1, wherein the sequence server is configured to generate the first user specific sequence of streaming videos by learning what videos the user enjoys by monitoring user viewing habits.

3. The system of claim 2, wherein the sequence server is configured to generate the first user specific sequence with an indication of a skip command generated at a touchpad finger input of the video display device.

4. The system of claim 3, wherein usage of the skip command according to a first value of a measured criterion is indicative of a dislike of the video being played when the command is issued.

5. The system of claim 4, wherein usage of the skip command according to a second value of the measured criterion is not indicative of a dislike of the video being played but rather of a neutrality in regard to the video.

6. The system of claim 5, wherein usage of the skip command according to a third value of the measured criterion is not indicative of a dislike or neutrality in regard to the video being played but rather of a liking of the video.

7. The system of claim 3, wherein the sequence server is configured to generate the first user specific sequence with a received indication of a skip command generated at the touchpad finger input of the video display device, the skip command generated in response to detecting a swipe at the touchpad finger input.

8. The system of claim 4, wherein the video display device is configured to interpret a swipe from right to left on the touchpad finger input as a forward skip command.

9. The system of claim 4, wherein the video display device is configured to interpret a swipe from left to right on the touchpad finger input as a reverse skip command.

10. The system of claim 4, wherein the video display device is configured to interpret a swipe from right to left on the touchpad finger input as a reverse skip command.

11. The system of claim 4, wherein the video display device is configured to interpret a swipe from left to right on the touchpad finger input as a forward skip command.

12. A method for providing a sequence of clips to a user with a video provisioning system, the method comprising:
associating each of a plurality of tags with one or more clips wherein at least one tag is associated with two or more clips, and wherein at least one clip is associated with two or more tags;
displaying a first clip V1 to the user;
determining if the user has watched the first clip V1 until the end of the clip;
increasing a value of a first tag weight of a plurality of tag weights of a given tag if the determination indicates that the user has watched the first clip until the end of the clip;
displaying a second clip V2 to the user;
determining if the user has watched the second clip V2 until the end of the second clip V2 or if the user has skipped to a third clip V3 after watching the second clip for more or less than a first threshold amount of time less than the full clip duration; and
decreasing a value of a first tag weight of a plurality of tag weights of a given tag if the determination indicates that the user has watched the second clip for less than the first threshold amount of time.

13. The method of claim 12, further comprising maintaining, without increasing or decreasing a value of a first tag weight of a plurality of tag weights of a given tag, if a determination indicates that the user has watched the second clip V2 for less than the first threshold amount but more than a second threshold less than the first threshold.

14. The method of claim 13, wherein the second threshold is in the range of 2-4 seconds and is also less than the full clip duration.

15. The method of claim 12, wherein the first threshold is less than the full clip duration and is in the range of 7-15 seconds.

16. The method of claim 12, further comprising placing a clip in a sequence server queue and creating a sequence of scored clips, wherein each of the clips in the sequence is scored above a threshold.

17. A method for providing a sequence of clips to a user, the method comprising:
(a) displaying a clip to the user;
(b) monitoring how much of the clip the user watches before providing a playback command input action if any;
(c) determining based upon the monitoring if the user has watched the clip until the end of the clip and if so determined increasing a value of a clip attribute indicative of affinity to the attribute, clip, or another attribute associated with the clip or the user;
(d) determining based upon the monitoring if the user has watched the clip for more or less than a first threshold period of time before providing the playback command input action, said first threshold less than the entire duration of the clip, and if so determined decreasing a value of a clip attribute indicative of affinity to the attribute, clip, or another attribute associated with the clip or the user;
(e) causing an ordered sequence of a plurality of clips not including the displayed clip to be generated, wherein at least one clip in the sequence is selected for inclusion in the sequence because of a change in attribute value or an overall score based upon attribute values attributable to either the increase or decrease created as a result of the determinations of steps (c) or (d).

18. The method of claim 17, further comprising ordering the sequence based at least in part upon the determinations of steps (c) or (d), wherein the order of the clips in the plurality is determined based at least in part upon viewing duration in relation to the first threshold and the overall clip duration.

19. The method of claim 18, further comprising determining based upon the monitoring if the user has watched the clip for more or less than a second threshold period of time, said second threshold period of time less than said first threshold period of time, and if so determined maintaining a value of a clip attribute indicative of affinity to the attribute, clip, or another attribute associated with the clip or the user at a preexisting level.

20. The method of claim 17, wherein the first threshold is in the range of five to fifteen seconds.

21. The method of claim 17, wherein the first threshold is in the range of 20-40% of the overall clip duration, but not less than five seconds, whichever is greater.

22. A method for providing a sequence of clips to a user, the method comprising:
(a) displaying a clip to the user;
(b) monitoring how much of the clip the user watches before providing a skip command if any such command is provided;
(c) determining based upon the monitoring if the user has watched the clip for more than a first threshold period of time but less than the full duration of the clip before providing the a skip command, and if so determined decreasing a value of a clip attribute indicative of affinity to the attribute, clip, or another attribute associated with the clip or the user; and
(d) causing an ordered sequence of a plurality of clips not including the displayed clip to be generated, wherein at least one clip in the sequence is selected for inclusion in the sequence because of a change in attribute value or an overall score based upon attribute values attributable to either the increase or decrease created as a result of the determination of step (c).

23. The method of claim 22, further comprising ordering the sequence based at least in part upon the determination of step (c), wherein the order of the clips in the plurality is determined based at least in part upon viewing duration in relation to the first threshold and the overall clip duration.

24. The method of claim 22, further comprising determining based upon the monitoring if the user has watched the clip for more or less than a second threshold period of time, said second threshold period of time less than said first threshold period of time, and if so determined maintaining a value of a clip attribute indicative of affinity to the attribute, clip, or another attribute associated with the clip or the user at a preexisting level.

25. The method of claim 22, wherein the first threshold is in the range of five to fifteen seconds.

26. The method of claim 22, wherein the first threshold is in the range of 20-40% of the overall clip duration, but not less than five seconds, whichever is greater.

27. A method for providing a sequence of clips to a user with a video provisioning system, the method comprising:
associating each of a plurality of tags with one or more clips wherein at least one tag is associated with two or more clips, and wherein at least one clip is associated with two or more tags;
displaying a first clip V1 to the user;
determining how much of the first clip V1 the user has watched;
increasing a value of a first tag weight of a plurality of tag weights of a given tag if the determination indicates that the user has watched the first clip V1 until a satisfaction threshold viewing time;
displaying a second clip V2 to the user;
determining if the user has watched the second clip v2 until the satisfaction threshold viewing time or if the user has skipped to a third clip V3 after watching the second clip for more or less than a first threshold amount of time less than the satisfaction threshold viewing time; and
decreasing a value of a first tag weight of a plurality of tag weights of a given tag if the determination indicates that the user has watched the second clip for less than the first threshold amount of time.
